(19) United States
(12) Patent Application Publication
(10) Pub. No.: US 2024/0295070 A1
(43) Pub. Date: Sep. 5, 2024

(54) ARTICLES WITH HYDROPHOBIC COATINGS OF BORONIC ACID-CONTAINING SILOXANE POLYMERS AND METHODS OF MAKING THEM

(71) Applicant: University of Rochester, Rochester, NY (US)

(72) Inventors: Matthew Z. YATES, Fairport, NY (US); Benjamin L. MILLER, Penfield, NY (US); Jeffrey W. BEARD, Greece, NY (US)

(73) Assignee: University of Rochester, Rochester, NY (US)

(21) Appl. No.: 18/574,021

(22) PCT Filed: Jun. 27, 2022
(86) PCT No.: PCT/US2022/035185

§ 371 Date: Dec. 23, 2023

Related U.S. Application Data
(60) Provisional application No. 63/215,221, filed on Jun. 25, 2021.

(51) Int. Cl. D06M 15/643

(52) U.S. Cl. CPC D06M 15/643; D06M 2200/12

(57) ABSTRACT

The invention provides articles of manufacture having a surface of a boronic acid-containing siloxane polymer bonded to a cellulose-containing material. The invention further provides methods of making such articles of manufacture. The surface of the cellulose-containing material covered by the bonded boronic acid-containing siloxane polymer is hydrophobic and keeps water from soaking into the article of manufacture. In some embodiments, the invention provides analytic devices in which a hydrophobic coating is applied to a material to defining one or more channels. The one or more channels may contain reagents that can react with analytes if the analytes are present in fluids introduced into the one or more channels.

### CROSS-REFERENCE TO RELATED APPLICATIONS

This application claims the benefit of, and priority to, U.S. Provisional Application Ser. No. 63/215,221 filed Jun. 25, 2021, the entire contents of which are hereby incorporated by reference.

### STATEMENT OF FEDERAL FUNDING

This invention was made with government support under grant U54 EB027049 awarded by the National Institute of Biomedical Imaging and Bioengineering of the National Institutes of Health. The government has certain rights in the invention.

### PARTIES TO JOINT RESEARCH AGREEMENT

Not applicable.

### BACKGROUND OF THE INVENTION

Since the first demonstrations that hydrophobic channels patterned in paper could serve as the basis for inexpensive, disposable diagnostic assays, the field of microfluidic paper-based analytical devices, or “μPADs,” has rapidly expanded; μPADs have proven to be valuable bioanalytical tools for a broad range of applications.

A critical aspect of achieving broad use of these assays is the availability of scalable processes for their manufacture. The earliest example of patterning a hydrophobic channel on paper featured the use of a heated wire pattern to transfer wax from a paraffin-saturated tissue to a paper substrate. Much of the recent work in the field has likewise focused on the use of wax printing to pattern the fluidic channels. Unfortunately, scaleup of this technology to commercial manufacturing is challenging, and the workhorse printer used for lab-scale production of devices (the Colorqube™, Xerox Corp., Norwalk, CT) is no longer commercially available. Wax barriers are also subject to breakdown and leakage caused by surfactants commonly used in sample diluents. Many other approaches have been described, including covalent or noncovalent modification of paper substrates with various hydrophobic materials. For example, one group reported applying poly(dimethylsiloxane) (“PDMS”) with a modified pen-plotter. See, Bruzewicz, et al., Anal. Chem., 2008, 80:3387-3392. As an alternative to printing polymeric siloxanes, Brook and colleagues reported use of a consumer-grade inkjet printer to dispense siloxane monomers and a Lewis acid boron catalyst. See, Rajendra, et al., Analyst, 2014, 139:6361-6365. Polymerization of the siloxanes after printing yielded a hydrophobic barrier. Id.

Lateral flow assays and other assay types are discussed in, for example, Sachdeva et al., Front. Bioeng. Biotechnol., 2021, https://doi.org/10.3389/fbioe.2020.602659; Pesaran et al., Biosensors 2021, 11(2):44; https://doi.org/10.3390/bios 11020044; Strong et al., Nature Scientific Reports, 2019, 9:7, DOI: 10.1038/s41598-018-37029-0; and Liu et al., Chem Engineering J, 2018, 332:695-701.

Yamada et al., Analyst, 2014, 139:1637-1643, summarize the advantages of μPADs and stated that the “reported printing technologies for the microfluidic patterning of paper substrates” as of 2014 were plotting, wax printing, flexographic printing, wax screen printing, and, in their own work, ink jet printing. Fabrication of μPADs as of 2019 was reviewed in Lim et al., Molecules 2019, 24(16), 2869; https://doi.org/10.3390/molecules24162869.

It would be desirable to have additional options for providing hydrophobic barriers on paper and other cellulose-containing materials. It would further be desirable to have additional methods and compositions for providing microfluidic, paper-based analytical devices, and to be able to provide those devices at lower cost than currently available technologies. Surprisingly, the present invention fulfills these and other needs.

### BRIEF SUMMARY OF THE INVENTION

In a first group of embodiments, the invention provides articles of manufacture comprising a boronic acid-containing siloxane polymer bonded to a surface of a cellulose-containing material. In some embodiments, the boronic acid-containing siloxane polymer is the product of a siloxane reacted with a vinyl-R-boronic acid, where “R” is alkyl or aryl. In some embodiments, the vinyl-R-boronic acid is vinyl phenylboronic acid, 4-vinyl phenylboronic acid, 3-vinyl phenylboronic acid, or B-3-buten-1-yl boronic acid. In some embodiments, the vinyl-R-boronic acid is 4-vinyl phenylboronic acid. In some embodiments, the “product of a siloxane reacted with a vinyl-R-boronic acid” is (methylhydrosiloxane)-dimethylsiloxane copolymer, trimethylsiloxane terminated, (epoxycyclohexylethyl)methylsiloxane-dimethylsiloxane copolymer, (mercaptopropyl)methylsiloxane-dimethylsiloxane copolymer, (chloropropyl)methylsiloxane-dimethylsiloxane copolymer, or polymethylhydrosiloxane homopolymer. In some embodiments, the product of a “siloxane reacted with a vinyl-R-boronic acid” is (methylhydrosiloxane)-dimethylsiloxane copolymer. In some embodiments, the boronic acid-containing siloxane polymer is the product of reacting aminophenyl boronic acid with epoxide functional silicone, of reacting vinylphenyl boronic acid with thiol functional silicone, or of reacting bis(pinacolato)diboron with chloro-alkyl functionalized silicone. In some embodiments, the boronic acid-containing siloxane polymer is compound 3 (“BorSilOx”) as shown in Scheme 1. In some embodiments, the cellulose-containing material is nitrocellulose. In some embodiments, the cellulose-containing material is paper. In some embodiments, the cellulose-containing material is cotton or cotton cloth. In some embodiments, the cotton cloth is 85% or more cotton. In some embodiments, the cellulose-containing material is cardboard. In some embodiments, the cellulose-containing material is wood. In some embodiments, the cellulose-containing material is a garment. In some embodiments, the garment is a jacket, shirt, pair of shorts, or pair of pants. In some embodiments, the article is a banner or a flag. In some embodiments, the article is a microfluidic analytical device. In some embodiments, the boronic acid-containing siloxane polymer is bonded to said cellulose-containing material in a pattern. In some embodiments, the pattern in which said boronic acid-containing siloxane polymer is bonded to said cellulose-containing material defines a central channel of cellulose-containing material not bonded to said boronic acid-containing siloxane polymer. In some embodiments, the article of the preceding sentence is a microfluidic analytical device. In some embodiments, the microfluidic analytical device of the preceding sentence is a lateral flow assay. In some embodiments of the preceding four sentences, the boronic acid-containing siloxane polymer is compound 3 (“BorSilOx”) as shown in Scheme 1.

In another group of embodiments, the invention provides methods of making an article of manufacture with a hydrophobic surface, comprising (a) contacting a first surface of a cellulose-containing material with a solution of a boronic acid-containing siloxane polymer in a solvent, under conditions allowing said boronic acid-containing siloxane polymer to bond to said first surface, and (b) drying said solution on the first surface, thereby making an article of manufacture with a first hydrophobic surface on the cellulose-containing material. In some embodiments, the drying in step (b) is at room temperature. In some embodiments, the drying in step (b) is at a temperature above room temperature. In some embodiments, the temperature above room temperature is from 30° C. to 160° C. In some embodiments, the temperature above room temperature is from 90° C. to 130° C. In some embodiments, the temperature above room temperature is 110° C.±10° C. In some embodiments, the cellulose-containing material is nitrocellulose. In some embodiments, the cellulose-containing material is paper. In some embodiments, the cellulose-containing material is cotton or cotton cloth. In some embodiments, the cotton cloth is 85% or more cotton. In some embodiments, the cellulose-containing material is cardboard. In some embodiments, the cellulose-containing material is wood. In some embodiments, the cellulose-containing material is a garment. In some embodiments, the said cellulose-containing material has a second surface and the second surface is contacted with a solution of a boronic acid-containing siloxane polymer in a solvent, under conditions allowing said boronic acid-containing siloxane polymer to bond to the second surface. In some of these embodiments, the article is a garment. In some of these embodiments, the article is a flag or a banner. In some embodiments, the article is a microfluidic analytical device. In some embodiments, the microfluidic analytical device is a lateral flow assay. In some embodiments, the boronic acid-containing siloxane polymer is the product of reacting a siloxane with a vinyl-R-boronic acid, where “R” is alkyl or aryl. In some embodiments, the vinyl-R-boronic acid is vinyl phenylboronic acid, 4-vinyl phenylboronic acid, 3-vinyl phenylboronic acid, or B-3-buten-1-yl boronic acid. In some embodiments, the vinyl-R-boronic acid is 4-vinyl phenylboronic acid. In some embodiments, the “product of reacting a siloxane with a vinyl-R-boronic acid” is (methylhydrosiloxane)-dimethylsiloxane copolymer, trimethylsiloxane terminated, (epoxycyclohexylethyl)methylsiloxane-dimethylsiloxane copolymer, (mercaptopropyl)methylsiloxane-dimethylsiloxane copolymer, (chloropropyl)methylsiloxane-dimethylsiloxane copolymer, or polymethylhydrosiloxane homopolymer. In some embodiments, the “product of reacting a siloxane with a vinyl-R-boronic acid” is (methylhydrosiloxane)-dimethylsiloxane copolymer. In some embodiments, the boronic acid-containing siloxane polymer is the product of reacting aminophenyl boronic acid with epoxide functional silicone, of reacting vinylphenyl boronic acid with thiol functional silicone, or of reacting bis(pinacolato)diboron with chloro-alkyl functionalized silicone. In some embodiments, the boronic acid-containing siloxane polymer is compound 3 (“BorSilOx”) as shown in Scheme 1. In some embodiments, the boronic acid-containing siloxane polymer is applied to said cellulose-containing material in a pattern. In some embodiments, the pattern in which the boronic acid-containing siloxane polymer is applied to the cellulose-containing material defines one of more channels or areas of cellulose-containing material not coated by the boronic acid-containing siloxane polymer. In some embodiments, the one or more channels or areas of cellulose-containing material not coated by the boronic acid-containing siloxane polymer is dyed or inked after said polymer has dried on the cellulose-containing material. In some embodiments, the dyed or inked channels or areas of the cellulose-containing material not coated by the boronic acid-containing siloxane polymer is then contacted with a boronic acid-containing siloxane polymer under conditions allowing the boronic acid-containing siloxane polymer to bond to the dyed or inked channels or areas of cellulose-containing material. In some embodiments, the article is a microfluidic analytical device. In some embodiments, the microfluidic analytical device is a lateral flow assay. In some embodiments, the solvent is an alcohol. In some embodiments, the alcohol is ethanol or butanol. In some embodiments, the solvent is an organic solvent other than an alcohol. In some embodiments, the solution is applied to the cellulose-containing material by an inkjet printer. In some embodiments, the solution is applied to the cellulose-containing material by rolling printing. In some embodiments, the

### BRIEF DESCRIPTION OF THE DRAWINGS

FIG. 1 is a photograph showing a sample of 100% cotton cloth. Ink was used to divide the cloth into three sections (left, center, and right) by drawing vertical lines. The center section was coated with ten μL of 5 wt % exemplar BorSilOx polymer, and allowed to dry at 110° C. for 1 hour. After drying, one 2.5 μL droplet of distilled water and one 2.5 μL droplet of distilled water to which blue food coloring had been added were applied to the center section. One 2.5 μL droplet of distilled water was applied to the left section and one 2.5 μL droplet of distilled water to which blue food coloring had been added was applied to the right-hand side of the sample. The photograph shows that the undyed water droplet and the blue-dyed water droplet applied to the treated section of the towel both beaded on the cloth, while the drops placed on the untreated cloth on either side soaked into the cloth.

FIG. 2 is a photograph showing a sample of cotton gauze that was divided into three sections and whose center section was then coated with polymer as described above for FIG. 1. As with FIG. 1, after the polymer was allowed to dry, one 2.5 μL droplet of distilled water and one 2.5 μL droplet of distilled water to which blue food coloring had been added were applied to the center section. A One 2.5 μL droplet of distilled water was applied to the left section and one 2.5 μL droplet of distilled water to which blue food coloring had been added was applied to the right-hand side of the sample. The photograph shows that the undyed water droplet and the blue-dyed water droplet applied to the treated section of the towel both beaded on the gauze, while the drops placed on the untreated gauze on either side soaked into it.

FIG. 3 is a photograph showing a sample of Whatman® Grade 1 chromatography paper that was divided into three sections and whose center section was then coated with polymer as described above for FIG. 1. As with FIG. 1, after the polymer was allowed to dry, one 2.5 μL droplet of distilled water and one 2.5 μL droplet of distilled water to which blue food coloring had been added were applied to the center section. One 2.5 μL droplet of distilled water was applied to the left section and one 2.5 μL droplet of distilled water to which blue food coloring had been added was applied to the right-hand side of the sample. The photograph shows that the undyed water droplet and the blue-dyed water droplet applied to the treated section of the paper both beaded on the paper, while the drops placed on the untreated paper on either side soaked into the paper.

FIG. 4 is a photograph showing a sample of a commercial grade paper towel used in office building restrooms. The towel was divided into three sections and the center section was then coated with polymer as described above for FIG. 1. As with FIG. 1, after the polymer was allowed to dry, one 2.5 μL droplet of distilled water and one 2.5 μL droplet of distilled water to which blue food coloring had been added were applied to the center section. One 2.5 μL droplet of distilled water was applied to the left section and one 2.5 μL droplet of distilled water to which blue food coloring had been added was applied to the right-hand side of the sample. The photograph shows that the undyed water droplet and the blue-dyed water droplet applied to the treated section of the towel both beaded, while the drops placed on the untreated towel on either side soaked into the towel.

FIG. 5 is a photograph showing a sample of a well-known of brand paper towel marketed to consumers. The paper towel was divided into three sections and the center section then coated with polymer as described above for FIG. 1. As with FIG. 1, after the polymer was allowed to dry, one 2.5 μL droplet of distilled water and one 2.5 μL droplet of distilled water to which blue food coloring had been added were applied to the center section. One 2.5 μL droplet of distilled water was applied to the left section and one 2.5 μL droplet of distilled water to which blue food coloring had been added was applied to the right-hand side of the sample. The photograph shows that the undyed water droplet and the blue-dyed water droplet applied to the treated section of the towel both beaded on the towel, while the drops placed on the untreated towel on either side soaked into the towel.

FIG. 6 is a photograph showing a sample of a well-known brand of laboratory “wipe” that was divided into three sections and whose center section was then coated with polymer as described above for FIG. 1. As with FIG. 1, after the polymer was allowed to dry, one 2.5 μL droplet of distilled water and one 2.5 μL droplet of distilled water to which blue food coloring had been added were applied to the center section. One 2.5 μL droplet of distilled water was applied to the left section and one 2.5 μL droplet of distilled water to which blue food coloring had been added was applied to the right-hand side of the sample. The photograph shows that the undyed water droplet and the blue-dyed water droplet applied to the treated section of the wipe both beaded, while the drops placed on the untreated wipe on either side soaked into the wipe.

FIG. 7 is a photograph showing a sample of Kleenex® brand tissue that was divided into three sections and whose center section was then coated with polymer as described above for FIG. 1. As with FIG. 1, after the polymer was allowed to dry, one 2.5 μL droplet of distilled water and one 2.5 μL droplet of distilled water to which blue food coloring had been added were applied to center section. One 2.5 μL droplet of distilled water was applied to the left section and one 2.5 μL droplet of distilled water to which blue food coloring had been added was applied to the right-hand side of the sample. The photograph shows that the undyed water droplet and the blue-dyed water droplet applied to the treated section of the tissue both beaded, while the drops placed on the untreated paper on either side soaked into the tissue.

FIG. 8 is a photograph showing a sample of a commercial grade, single-ply toilet paper that was divided into left, center, and right sections and whose center section was then coated with polymer as described above for FIG. 1. As with FIG. 1, after the polymer was allowed to dry, one 2.5 μL droplet of distilled water and one 2.5 μL droplet of distilled water to which blue food coloring had been added were applied to the center section. One 2.5 μL droplet of distilled water was applied to the left section and one 2.5 μL droplet of distilled water to which blue food coloring had been added was applied to the right-hand side of the sample. The photograph shows that the undyed water droplet and the blue-dyed water droplet applied to the treated section of the paper both beaded, while the drops placed on the untreated paper on either side soaked into the paper.

FIG. 9 is a photograph showing a sample of cardboard from a box. The cardboard was divided into left, center, and right sections and the center section was then coated with polymer as described above for FIG. 1. As with FIG. 1, after the polymer was allowed to dry, one 2.5 μL droplet of distilled water and one 2.5 μL droplet of distilled water to which blue food coloring had been added were applied to the center, treated section. One 2.5 μL droplet of distilled water was applied to the left section and one 2.5 μL droplet of distilled water to which blue food coloring had been added was applied to the right-hand side of the cardboard. The photograph shows that the undyed water droplet and the blue-dyed water droplet applied to the treated section of the cardboard both beaded on it, while the drops placed on the untreated paper on either side soaked into the cardboard.

FIG. 10 is a photograph showing a sample of wood. The wood was divided into left and right sections. The left-hand side was coated with polymer as described above for FIG. 1. The right-hand side was divided vertically into two sections, one labeled “H₂O” and the lower one labeled “H₂O+Food Coloring.” As with FIG. 1, after the polymer was allowed to dry, one 2.5 μL droplet of distilled water and one 2.5 μL droplet of distilled water to which blue food coloring had been added were applied to the left-hand, treated side and identical droplets of each were applied to the right-hand side. The photograph shows that the undyed water droplet and the blue-dyed water droplet applied to the treated section of the wood beaded, while the drops placed on the untreated wood paper on either side soaked into the wood.

FIGS. 11A-D. FIG. 11A. FIG. 11A is a schematic diagram of a single paper divided into five exemplar multiplex, paper-based microfluidic analytical devices (μPADs). Each device has a hydrophobic coating around and defining a center well for the introduction of a fluid sample, and further around and defining arms fluidly connected to the center well extending from it to two terminal wells, which can be provided with reagents to react with analytes in the fluid sample. FIG. 11B. FIG. 11B is a photograph of Whatman® grade 1 filter paper which has had an exemplar BorSilOx polymer deposited on it in a pattern defining five μPADs, as in the schematic diagram set forth in FIG. 11A. Each μPAD consists of a central circular pad (10 mm in diameter) connected to two smaller pads (8 mm in diameter) through linear channels. This pattern was repeated for each u PAD with a continuous line to enable all five patterns to be drawn at constant pen velocity without lifting or stopping the pen. The pattern was then drawn using a 5 wt % ethanol solution of BorSilOx deposited at a volumetric flow rate of 1.5 μl s⁻¹ and a pen velocity of 1.6 cm s⁻¹. The filter paper was dried at room temperature, then placed in an oven at 100° C. for 30 minutes. An aqueous methylene blue solution was deposited in the defined, non-coated section pattern and allowed to dry, showing the pattern of the non-coated section. FIG. 11C. FIG. 11C is a photograph of a Whatman® grade 1 filter paper which has been made into five u PADs by coating the filter paper with an exemplar BorSilOx polymer defining a central non-coated section as described for FIG. 11B. The left-hand terminal well of each μPAD was provided with a reagent that undergoes a colorimetric change if contacted with an aqueous solution with a basic pH, while the right-hand terminal well was provided with a reagent undergoing a colorimetric change if contacted with an aqueous solution containing glucose. The top μPAD was a control to which no aqueous solution was applied. The second μPAD from the top shows the colorimetric change or changes when a solution with a pH of 6.5, and containing glucose was applied to the central well. The third μPAD from the top shows the colorimetric change or changes when a solution with a pH 6.5, but not containing glucose, was applied to the central well. The fourth μPAD from the top shows the colorimetric change or changes when a solution with a pH of 8, and containing glucose, was applied to the central well. The bottom μPAD shows the colorimetric change or changes when a solution with a pH of 8, but not containing glucose, was applied to the central well. The results show that coating the surface of an exemplar cellulose-containing material with an exemplar BorSilOx coating formed μPADs that allowed multiplex detection of analytes in a solution.

FIGS. 12A-F presents images of pH and glucose multiplex assays produced on commercial single-ply paper towels using a piezoelectric microarrayer. FIG. 12A. FIG. 12A shows the print layout for an exemplar multiplex assay device that can be printed by the sciFLEXARRAYER SX user interface. The design shows the area of a cellulose-containing material to be printed with an exemplar BorSil hydrophobic polymer, BorSilOx (“polymer”), in a pattern leaving an uncoated area shaped like a capital letter “U”. The bottom of the “U” shaped area is the area to which an aqueous solution can be applied to be tested for the presence of an analyte of interest. This area may be dyed to assist the practitioner in seeing where to apply the solution (this area is labeled “application indicator” in FIG. 12A). The left-hand arm of the “U” in the exemplar assay configuration shown in FIG. 12A is labeled as “pH reagent,” designating that it is to be printed with a reagent that undergoes a colorimetric change when contacted with an aqueous solution having a basic pH (“pH reagent”), while the right-hand arm of the “U” in FIG. 12A is labeled “glucose reagents,” showing that it is to be printed with reagents that undergo a colorimetric change when contacted with an aqueous solution containing glucose. FIG. 12B. FIG. 12B is a photograph showing a paper towel on which two assay devices have been printed. The right-hand assay device (labeled “dry assay”) is formed by an exemplar BorSilOx hydrophobic polymer that has been printed on the towel by a microarrayer, leaving an uncoated area defining the assay area and which contains reagents for detecting pH (“pH indicator”) and for detecting glucose (“glucose indicator”) also printed on the towel by the microarrayer. For all of the assays shown in FIGS. 12B-F, the pH indicator was bromothymol blue and the glucose reagent was a solution of glucose oxidase and horseradish peroxidase. As the polymer coating is hard to see, it is surrounded by a drawn dotted border line showing the boundaries of the assay. Coomassie blue has been applied at the bottom of the “U”-shaped assay (in the area labeled “application indicator”) to make it easier for the user to see where to apply the test sample. The left-hand assay device (labeled “wet assay”) shows an assay printed on the same towel in the same way, leaving an area not coated by the hydrophobic polymer, with the left and right arms of the “U”-shaped uncoated area labeled as “hydrophilic channels” to emphasize they are fluidly connected to the application area at the bottom of the “U”. Three μL of water were applied to the “application indicator” area and the paper towel was then allowed to dry. The photo shows that the solution stayed within the area of the paper towel that had not been coated with the exemplar BorSil polymer. FIG. 12C. FIG. 12C is a photograph of a paper towel to which an exemplar BorSilOx hydrophobic polymer has been printed to create three columns, with each column containing within it three uncoated areas defining “U”-shaped assay devices. The sciFLEXARRAYER SX printed both the polymer coating the towel and the reagents for detection of glucose and of basic pH, as described above for FIG. 12B. For each column, a solution of 1× phosphate buffered saline (“PBS”) was applied that had a neutral pH, but that contained the concentration of glucose shown at the bottom of the column. Due to the size constraints of the sciFLEXARRAYER SX, an assay device was printed on a separate paper towel to provide a control that would allow quantitation of the results. The control assay device was printed in the same manner and using the same reagents as those described above, and was contacted with 1×PBS of neutral pH, but which contained no glucose. FIG. 12D. FIG. 12D is a photograph of a paper towel to which an exemplar BorSil hydrophobic polymer, BorSilOx, has been printed to create three columns, each containing three “U”-shaped assays printed with the reagents as described for FIG. 12B. For each column, a solution of 1×PBS was applied which contained no glucose, but which was of one of three different pHs, which are listed at the bottom of the respective columns. As with FIG. 12C, a control was run on an assay device printed on a separate sheet of paper towel. In this case, the control was 1× PBS with a pH of 7.4. FIG. 12E. FIG. 12E is a graph showing the quantitative results of the assays shown in FIG. 12C versus the control assay. Data presented as mean+/−SD, n=3, P-values are calculated using Student's two-tailed t-test, *P≤0.05, **P≤0.01, ***P≤0.001.

FIG. 12F. FIG. 12F is a graph showing the quantitative results of the assays shown in FIG. 12D versus the control assay, derived using the ImageJ image processing program and JMP statistical software. Data is presented using same statistical measures as stated for FIG. 12E.

FIGS. 13A-D. FIG. 13A. FIG. 13A, top panel, shows a schematic drawing of a prototype roller stamp for applying a BorSilOx hydrophobic polymer to a cellulose-containing surface to coat the surface in a manner defining an uncoated area for conducting a lateral flow assay. In this prototype, a polymer-assay stamp is wrapped around a bread rolling pin and secured with rubber bands. FIG. 13A, bottom panel, shows, on the left, a schematic drawing of the stamp produced by applying BorSilOx polymer to a surface using the polymer stamp. FIG. 13A, bottom panel, shows the preparation of an assay for detecting pH, by showing, sequentially from the left, BorSilOx polymer applied by the stamp to a nitrocellulose sheet after the polymer has dried, the application of reagents (in this example, bromothymol blue and bromophenol blue applied to the top and bottom wells, respectively) of the assay and, finally, the addition to the assay device of buffer containing the test sample. FIG. 13B. FIG. 13B, top panel, is a drawing of an assembled all-in-one rolling printer on a print platform with 3D printed putty molds and resulting assay stamps removed from the molds. The stamp roller is a 3D printed roller with the polymer deposition stamp glued to its surface. FIG. 13B (i) is a cartoon image of an aerial view of the rolling printer being rolled over a section of paper substrate on the print platform. FIG. 13B (ii) is a cartoon image illustrating the completion of the rolling process, resulting in two multiplex lateral flow assays. Under FIG. 13B (ii) is a schematic of the printed assay device and, under that, photographs showing the assay workflow of drying the simultaneously printed BorSilOx and reagents (bromothymol blue and bromophenol blue) on Whatman® filter paper (left two photos) and on nitrocellulose (right two photos), and the addition of test sample to each. FIG. 13C. FIG. 13C shows, on the left, a schematic of a printed assay device for multiplex detection of glucose in a test sample and the pH of the test sample. On the right, it presents photographs showing the assay workflow of drying the simultaneously printed BorSilOx and reagents (bromothymol blue and bromophenol blue) on Whatman® Q1. Polymer and reagents were printed on the paper and dried for 1 hour at room temperature before samples were applied to the center zone of the assay device The top right panel shows the assay workflow and result in which a test sample of Nanopure™ water containing HCL providing a pH of 5.8 and 500 mg/dL of α-D-glucose (“glucose+”) was applied to the center well of the device, while the bottom right panel shows the assay workflow and result in which a test sample of Nanopure™ water containing HCL providing a pH of 2.5, but not glucose (“glucose−”) was applied to the center well of the device. The dried assays produced colorimetric results. FIG. 13C. FIG. 13C shows, on the left, a schematic of a printed assay device for multiplex detection of the pH of test samples and, on the right, printed pH assay devices defined by a hydrophobic polymer printed at the same time as solutions of the pH detection reagents. The photos were taken following application of 1×PBS with pH values of 3, 6, 8, or 10, respectively. FIG. 13C (i) shows enlarged images of dried bromophenol blue test zones, while FIG. 13C (ii) shows enlarged bromothymol blue test zones. The enlarged images were taken within 1 minute after applying the buffer, as it was noted that the color intensity decreased when the assays were dried.

FIG. 14. is a photograph showing the result of a study using an inkjet printer to apply the exemplar boronic acid-containing siloxane polymer BorSilOx in ethanol to paper. The exemplar polymer was applied to coat the paper in a pattern defining an area left uncoated by polymer, and therefore hydrophilic. The area defined by the polymer formed the letters “UR.” After the polymer was allowed to dry, water containing blue food dye was dropped onto the paper. As shown in the photograph, the dye dyed the hydrophilic areas not coated with the hydrophobic polymer, but did not dye the areas coated with the hydrophobic polymer, making the area defined by the polymer visible on the paper as the letters “UR.”

### DETAILED DESCRIPTION

### Introduction

As set forth in the Background, paper-based microfluidic analytical devices, or “μPADs,” have proven to be valuable bioanalytical tools for a broad range of applications. Unfortunately, their use has been limited by the difficulty of producing them at scale at a cost that makes their use practical for applications for which they would otherwise be well suited.

Surprisingly, the discoveries reported herein provide coatings for cotton, paper, nitrocellulose, and other materials that contain cellulose or diols, that render the materials hydrophobic and that can be applied using polar and non-toxic solvents, such as water or alcohol, at room temperature. The mild solvents used to apply the coating are compatible with standard inkjet printing hardware and with many biomaterials. Cotton cloth and paper treated with an exemplar hydrophobic coating of the invention had the same appearance and the same tactile properties as those of the starting materials. Thus, the inventive methods make possible the production of hydrophobic cotton, paper, nitrocellulose, cardboard, wood, and other materials that contain cellulose or diols. The hydrophobic materials that can be made by the inventive methods provide a number of advantages over hydrophobic materials made by currently available methods. For example, as noted in the Background, paper-based microfluidic analytical devices are currently made by depositing paraffin or wax on to paper to form microfluidic channels. Wax or paraffin, however, soften at relatively low temperatures, and μPADs made with them can be damaged if not stored properly or if used with reagents at temperatures higher than room temperature.

Articles made of the hydrophobic materials can be used for a variety of useful purposes. As noted, paper can be treated with the inventive coatings to make μPADs, or to define untreated areas that can then be dyed to produce patterns on the paper. Cotton treated with the inventive coatings can be used to make garments that are water resistant or waterproof, such as jackets, ski pants, shirts, or jeans, or can be treated to define untreated areas that can then be dyed to produce patterns on the cotton (and which can then be treated with the coatings to render the dyed areas hydrophobic as well. Cardboard provided with a hydrophobic coating by the inventive methods can be used to box and ship goods, protecting the box in case it is exposed to rain during shipment or delivery. Wood treated by the inventive methods can be used inside a building to reduce degradation of the wood if it becomes wetted, or can be used outside as part of a deck. Materials made with the hydrophobic coatings disclosed herein are therefore surprisingly more useful than similar articles of manufacture made hydrophobic by previously available coatings.

We report here that boronic acid-containing siloxane polymers render cellulosic substrates hydrophobic. A reaction scheme of the synthesis of an exemplar boronic acid-containing siloxane polymer via a platinum-catalyzed hydrosilylation reaction between an inexpensive siloxane polymer, 1, and vinylboronic acid, 2, is shown below in Scheme 1. In some embodiments, the boronic acid-containing siloxane polymer has the formula of polymer 3, as shown in Scheme 1. For convenience of reference, the boronic acid-containing siloxane polymer referred to in Scheme 1 as 3 is sometimes referred to herein as “BorSilOx.”

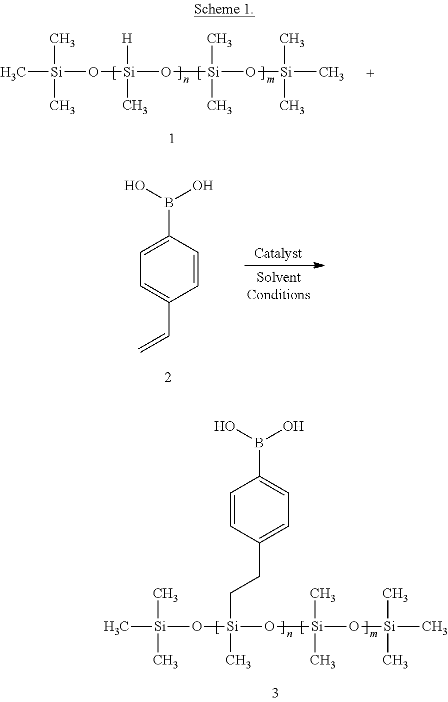

The catalyst for the hydrosilylation reaction is typically platinum. Various solvents for the reaction are known. For example, tetrahydrofuran, or “THF,” can be used under reflux. The exemplar BorSilOx used in the studies conducted in the course of the work reported herein was made at 60° C., with toluene as the solvent. The toluene was then removed and polymer 3 was then placed in another solvent, as discussed further below. It is assumed that persons wishing to make a boronic acid-containing siloxane polymer are familiar with hydrosilylation reactions and can choose appropriate catalysts, solvents, and reaction conditions. For ease of reference, the products formed by reacting different siloxanes with different vinyl-R-boronic acids (where “R” means an alkyl or an aryl) will generally be referred to herein as the product of reacting a siloxane with a vinyl-R-boronic acid, rather than by the chemical name of the reaction product, unless reference to the product of reacting a specific siloxane with a specific vinyl-R-boronic acid is intended.

The present invention arises from a serendipitous discovery. The present inventors were trying to develop glucose-sensitive polymers, by introducing a boronic acid functional group to a silicone polymer, following a procedure reported by another group, Brook et al., Chem. Commun. 2013, 49(14): 1392-1394 (hereafter, “Brooks 2013”), but without using the protecting groups Brook 2013 used to protect the boronic acid functional group. A series of methylhydroxsiloxane-co-dimethylsiloxane polymers were created by reacting commercially available vinyl phenylboronic acid to silicone polymers by the hydrosilylation reaction.

One of the present inventors purified the resulting polymers by filtration through standard Whatman® Grade 1 filter paper to remove a precipitate. After the filter paper had dried, water was added and it was noted that the water beaded and rolled off the surface of the filter. Further studies revealed that similar results were obtained using samples of other papers, of nitrocellulose, of swaths of 100% cotton cloth, of cardboard, and of wood. Similar results were not obtained, however, when the polymers were applied to nylon.

Without wishing to be bound by theory, it is believed that the boronic acid groups interacts with diol groups in cellulose in the materials, similar to the known interaction of boronic acid with saccharides. While the diol groups on cellulosic materials have been reacted in the past with alkyl ketene dimers, acetic anhydride, or other chemicals to form a hydrophobic surface, these prior methods have typically required harsh chemicals and processing conditions. By contrast, the present disclosure reveals that boronic acid-containing siloxane polymers can be used to form hydrophobic surfaces on cellulose-based materials (or other materials with available diol groups) under relatively mild conditions. Without wishing to be bound by theory, it is believed that the polymer attaches to the diols by covalent bonding or by hydrogen bonding. As used herein, the term “bonding,” when used to refer to the interaction between boronic acid-containing siloxane polymers and materials with cellulose on their surface, means that the boronic acid-containing siloxane polymer adheres to cellulose on the surface of the material in a manner such that the boronic acid-containing siloxane polymer does not wash off the material with an aqueous wash and is not easily removed.

Surprisingly, studies underlying the present disclosure further revealed that drying the BorSilOx polymer on the surface of the cellulose-containing material at a temperature higher than room temperature resulted in a much better coating than was obtained by drying the material at room temperature. Room temperature is commonly considered to be about 20-22° C. Drying at room temperature often resulted some degree of leakage through the hydrophobic barrier; drying at 110° C. for at least 30 minutes, however, typically eliminated that. Without wishing to be bound by theory, it is believed that the elevated temperature helps drive a faster formation of boronate esters in the reaction. The temperature used happened to be that of an oven kept on in the lab for other purposes. It is expected that other temperatures elevated over room temperature will also be useful, and that temperatures higher than 110° C. can be used as long as the cellulose-containing material is not damaged (for example, by oxidation) or catch on fire. Temperatures up and including 160° C. are considered reasonable conditions for bonding the polymer to the cellulose-containing material.

In some embodiments, the boronic acid-containing siloxane polymer coating is dried on the cellulose-containing material at a temperature of 30° C. or above. In some embodiments, the boronic acid-containing siloxane polymer coating is dried at a temperature of 35° C.±5° C., 40° C.±5° C., 45° C.±5° C., 50° C.±5° C., 55° C.±5° C., 60° C.±5° C., 65° C.±5° C., 70° C.±5° C., 75° C.±5° C., 80° C.±5° C., 85° C.±5° C., 90° C.±5° C., 95° C.±5° C., 100° C.±5° C., 105° C.±5° C., 110° C.±5° C., 115° C.±5° C., 120° C.±5° C., 125° C.±5° C., 130° C.±5° C., 135° C. ±5° C., 140° C.±5° C., 145° C.±5° C., 150° C.±5° C., or 155° C.±5° C., with higher temperatures up until 110° C. being preferred to lower ones. In some embodiments, the boronic acid-containing siloxane polymer coating is dried on the cellulose-containing material at a temperature of 95° C.±5° C. to 135° C.±5° C. In some embodiments, the boronic acid-containing siloxane polymer coating is dried on the cellulose-containing material at a temperature of 105° C.±5° C. to 115° C.±5° C.

### Boronic Acid-Containing Siloxane Polymers

As noted above, the exemplar boronic acid-containing siloxane polymer used in the studies reported herein was the one referred to above as BorSilOx. It is expected, however, that boronic acid-containing siloxane polymers other than BorSilOx can likewise in some embodiments to create articles of manufacture of the invention by the inventive methods. It is expected, for example, that commercially available reagents such as 3-vinyl phenylboronic acid (CAS No. 15016-32-0) and B-3-buten-1-yl boronic acid (CAS No. 379669-72-4). We believe 2-vinyl phenylboronic acid (CAS No. 15016-42-9) may also be useful in this regard, but may be less useful due to steric hindrance.

Formation of the boronic acid-containing siloxane polymer does not have to be by a hydrosilylation reaction. For example, 4-formyl phenylboronic acid (CAS No. CAS 87199-17-5) can be subjected to a reductive amination reaction with 9-11% aminopropyl(methylsiloxane)-dimethylsiloxane copolymer (CAS No. 99363-37-8, Gelest, Inc., Morrisville, PA, product code AMS-191) to form a boronic acid-containing siloxane polymer that can be used in the inventive methods. Other examples include reacting aminophenyl boronic acid with epoxide functional silicone, as discussed in Vogt, et al., Macromol Rapid Commun. 2012; 33(13):1108-13, doi: 10.1002/marc.201200144, reacting vinylphenyl boronic acid with thiol functional silicone, as discussed in Mompo-Rosello, et al., Microchem. J., 2021, 164:106018, doi.org/10.1016/j.microc.2021.106018, and reacting bis(pinacolato)diboron with chloro-alkyl functionalized silicone, as discussed in Atack and Cook, J. Am. Chem. Soc. (2016), 138(19):6139-6142, DOI: 10.1021/jacs.6b0315 (in this reaction scheme, the resulting pinacolato ester group would be removed prior to use).

The siloxane compound designated as compound 1 in Scheme 1 above, is (15-18% methylhydrosiloxane)-dimethylsiloxane copolymer, trimethylsiloxane terminated (CAS No. 68037-59-2, Gelest product code HMS-151, Gelest, Inc., Morrisville, PA). It is expected that other siloxanes and copolymers, such as 8-10% (epoxycyclohexylethyl)methylsiloxane-dimethylsiloxane copolymer (CAS No. 67762-95-2), 13-17% (mercaptopropyl)methylsiloxane-dimethylsiloxane copolymer (CAS No. 102783-03-9), 14-16% (chloropropyl)methylsiloxane-dimethylsiloxane copolymer (CAS No. 70900-20-8), or polymethylhydrosiloxane homopolymer can likewise be used. Any siloxane of interest can be readily tested to see if it forms a hydrophobic polymer when reacted with a boronic acid-containing compound as described herein. As persons of skill will appreciate, once any particular siloxane is reacted with any particular boronic acid-containing moiety to create the desired hydrophobic polymer, the hydrophobic polymer is a chemical entity that is derived from the starting materials and not strictly speaking a polymer of the starting materials themselves. For ease of reference, however, hydrophobic polymer formed by the reaction of a silicone-containing compound and a boronic-acid containing compound may sometimes be referred to herein as a polymer of the starting materials or as a product of reacting one starting material with the other.

It is expected that other siloxane polymers can be functionalized with vinyl-(R)-boronic acid (where (R) is an intervening alkyl or aryl group), such as the exemplar 4-vinylphenyboronic acid used in the studies reported herein, to form similar polymers (hereafter collectively referred to as “BorSil polymers”), which are likewise expected to confer hydrophobic properties on cellulose-containing materials that have not been treated in a way that renders their diol groups unavailable for reaction with the hydrophobic BorSil polymer.

Any particular BorSil polymer can be readily tested for its ability to render cellulose-containing materials hydrophobic. A sample of paper, cotton cloth, nitrocellulose, or another a cellulose-containing material of interest that is known not to be hydrophobic is obtained (any particular sample of such material can be tested to see if it is hydrophobic by dripping water onto it and observing to see if the water soaks into the material or beads on the material. If the water soaks into the material, the material is suitable to be used in the test, while if the water beads on the material, the material is already hydrophobic and is not suitable for the test, in which case another cellulose-containing material into which water does soak should be is selected). The sample of the material is contacted with a solution containing the BorSil polymer of interest, and the solution containing the polymer is allowed to dry on the material. Water is then dripped onto the material. If the water beads on the material, the BorSil polymer has rendered the material hydrophobic and is suitable for use in making hydrophobic articles from paper, cotton cloth, nitrocellulose, or another a cellulose-containing material of interest. In preferred embodiments, the BorSil polymer does not affect the appearance or tactile properties of the material.

To study the effect of modifying the silicone backbone of the boronic acid-containing siloxane polymer, three BorSilOx polymers were made, which differed in the percentage of the hydrosilane in repeating unit “n” of compound 1 of the silicone backbone which were modified with the phenylboronic acid group. A polymer is chosen with a set percentage of hydrosilane, which were then reacted with vinylboronic acid. The percentages of hydrosilane on the polymer used for the studies were 15%, 30%, and 50%. The attempts to generate 30% and 50% polymers resulted in a reactor filled with a gel-like result. For example, an attempt to form a hydrophobic coating using (45-55% methylhydrosiloxane)-dimethylsiloxane copolymer, trimethylsiloxane terminated, CAS No: 68037-59-2, resulted in an unusable gel. Without wishing to be bound by theory, it is believed that the gel resulted from cross-linking, most likely caused by the B—O—H groups from boronic acid being converted to B—O—Si groups during the hydrosilylation reaction. An attempt to use a mono-hydride terminated siloxane also failed to provide a hydrophobic coating. Without wishing to be bound by theory, it is believed that the polymer chain of a mono-hydride siloxane, which reacts with boronic acid only at the single terminus of the polymer chain having the hydride, and thus has only a single set of hydroxyl groups at one end of the polymer chain to interact with the surface of a cellulose-containing material, is not held in sufficiently close proximity to that surface to provide the surface with a hydrophobic coating.

Accordingly, for the exemplar BorSilOx polymer, the percentage of the hydrides functionalized with boronic acid is 5%, 6%, 7%, 8%, 9%, 10%, 11%, 12%, 13%, 14%, 15%, 16%, 17%, 18%, 19%, 20%, 21%, 22%, 23%, 24%, or 25%. Preferably, the percentage is between 10% and 20%, 11% and 19%, 12% and 18%, 13 and 17%, or 14% and 16%. In some embodiments, the percentage is 15%+1%. As persons of skill will appreciate, BorSil polymer chains have two ends and a length. In preferred embodiments, hydrides functionalized with boronic acid are present at both ends. Further, and as discussed in more detail below, in some preferred embodiments, the BorSil polymer chain has at least some hydrides functionalized with boronic acid disposed along the length of the chain.

It can readily be determined if a BorSil polymer with a particular percentage of modified hydrides is suitable for use in the inventive methods by making it, putting it in ethanol or butanol as a solvent, applying the resulting solution to a suitable substrate, such as Whatman® No. 1 filter paper, and allowing it to dry at room temperature or higher. The polymer is then tested for hydrophobicity by dripping or pouring water onto the surface of the paper. If the polymer can be smoothly applied to the substrate and if water beads and rolls off the surface of the paper after the polymer has dried on it, the polymer with that percentage of hydrides modified in the polymer is suitable for use in the inventive methods. If the polymer cannot be smoothly applied or if the water soaks into the paper after the polymer has dried on it, the polymer with that percentage of hydrides modified in the polymer is not suitable for use in the inventive methods.

As can be seen from referring to Scheme 1, above, vinylboronic acid reacts with hydrides distributed along the length of the siloxane polymer chain, resulting in a polymer chain that has boron atoms, each bearing two hydroxyl groups, distributed along the length of the polymer chain. Without wishing to be bound by theory, it is believed that when such boronic acid-containing siloxane polymers are placed in contacted with a cellulose-based material, interactions between the hydroxyl groups disposed on the boron atoms along the length of the polymer chain and the surface of the cellulose-based material hold the boronic acid-containing siloxane polymer closely to the surface of the cellulose-based material. Further, and again not wishing to be bound by theory, it is believed that siloxane polymer chains having borons bearing hydroxyl groups disposed along the length of the siloxane polymer chain bind to the surface of the cellulose-based material more robustly, and provide a better hydrophobic coating, than do polymer chains in which boron atoms bearing hydroxyl groups are present only at the ends of the polymer chains.

### Solvents

Studies using an exemplar BorSil polymer, BorSilOx, in which 15% of the silicone backbone was modified with the phenylboronic acid group (sometimes referred to herein as “15% BorSilOx”, found that the 15% BorSilOx polymer was soluble in both hydrophobic solvents, such as hexane and toluene, and in polar alcohols, including ethanol, n-butanol, and iso-butanol. When dissolved in ethanol, the BorSilOx polymer could be injected into water or into dilute aqueous pH buffers to form colloidal particles that were observed to be stable as a suspension for weeks. Example 5, below, reports that soaking a cellulose-containing material in a suspension of colloidal particles of the exemplar BorSilOx polymer rendered the material hydrophobic.

It is expected that dimethyl sulfoxide (“DMSO”) could be used as a solvent, but that it and other non-alcohol organic solvents will likely be less preferred due to disposal concerns, it is expected that alcohols will be the solvent of choice for many applications. If permitted by local regulations, alcohols can be disposed of by burning.

In embodiments in which alcohol is used, the solvent is preferably a primary or a secondary alcohol, such as ethanol, methanol, isopropyl alcohol, propanol, butanol, glycerol, or propylene glycol. In some embodiments, the alcohol is a primary alcohol. In some embodiments, the solvent is butanol. All forms are butanol (n-butanol, sec-butanol, isobutanol, and tert-butanol) are all expected to work. In some embodiments, the solvent is ethanol.

Examples 1 and 2 below report the deposition of a solution of the exemplar BorSil polymer BorSilOx dissolved in butanol using a piezoelectric microarrayer system.

Cellulose-Containing Materials that can be Rendered Hydrophobic Using Hydrophobic BorSil Polymers

As set forth in the Examples, an exemplar BorSil polymer, BorSilOx, was tested on nitrocellulose, cotton cloth, cotton gauze, cardboard, wood, and a variety of papers, including filter paper, chromatography paper, tissue paper, toilet paper, laboratory wipes, and paper towels, and was found to render each of the materials hydrophobic. Each of these materials is believed to have a plurality of diol groups on its surface, in sufficient density that hydrophobic BorSil polymers binding to the diols render hydrophobic the surface on which the polymer molecules attach. In contrast, BorSilOx did not render nylon hydrophobic. It is thus believed that hydrophobic BorSil polymers can render hydrophobic any cellulose-based material having a plurality of diol groups or pairs of hydroxyl groups in close proximity on its surface available for binding to the polymer in sufficient density. Whether any particular cellulose-based material has a sufficient density of diols available for binding to the polymer can be readily determined by simply contacting the surface of the cellulose-based material with a hydrophobic BorSil polymer of choice under conditions allowing binding of the polymer to any available diols, then contacting the surface of the material with water, and observing if the water beads on the surface or soaks into it. If the water beads on the surface, the material has a sufficient density of available diols. If the water soaks into the material, the material does not have a sufficient density of diols to be made hydrophobic with the hydrophobic BorSil polymer tested.

While the studies conducted in the course of preparing the present disclosure used cotton cloth and gauze that were 100% cotton, it is believed that cloths made of fabrics comprising cotton will achieve some water resistance, with the resistance to water soaking into the fabric increasing along with the percentage of cotton. It is believed that cloths containing cotton in percentages of 85% or more treated with a hydrophobic BorSil polymer will be effectively waterproof. In some embodiments, the garments are 85%, 86%, 87%, 88%, 89%, 90%, 91%, 92%, 93%, 94%, 95%, 96%, 97%, 98%, 99%, or more, cotton, with each successively higher percentage being more preferred.

It is understood that some papers or other cellulose-based materials may be manufactured with a plastic film or other coating that is impermeable to water. It is expected that such materials would not need a hydrophobic BorSil polymer layer to be hydrophobic. It is further expected that the presence of a plastic film or a similar coating on the cellulose-containing material would block the hydrophobic BorSil polymer from contacting diols on the surface of the material, which renders the diols unavailable for contact with the polymer. Such coated materials are therefore not suitable for use in the inventive methods.

### Hydrophobicity and Contact Angles

An exemplar BorSil polymer, BorSilOx, was applied to a variety of materials to test if it rendered then hydrophobic. Hydrophobicity was measured by determining the contact angle between a water droplet applied to the material and the surface of the material. In the art, materials with a contact angle of less than 90° are generally considered to be hydrophilic, while materials with a contact angle of more than 90° are generally considered to be hydrophobic.

In studies underlying the present disclosure, materials that the water soaked into were considered to be hydrophilic and to have a contact angle of 0°. In contrast, water tended to bead and run off cellulose-containing materials that had been coated with the inventive coatings. Table 1, below, sets forth the contact angles measured for a variety of materials coated with the exemplar BorSilOx polymer at 110° C.

TABLE 1

| Material | Contact Angle (degrees) |
|---|---|
| Chromatography Paper | 153.4 |
| Laboratory wipe | 138.7 |
| Cotton Gauze | 148.3 |
| Cotton Cloth | 164.4 |
| Toilet Paper | 120.6 |
| Commercial Grade Paper Towel | 168.3 |
| Brand Name Paper Towel | 144.5 |
| Kleenex ® brand tissue | 167.2 |
| Cardboard | 131.9 |
| Wood | 116.8 |

### Applying Hydrophobic Polymer by Inkjet Printer to Create Patterns

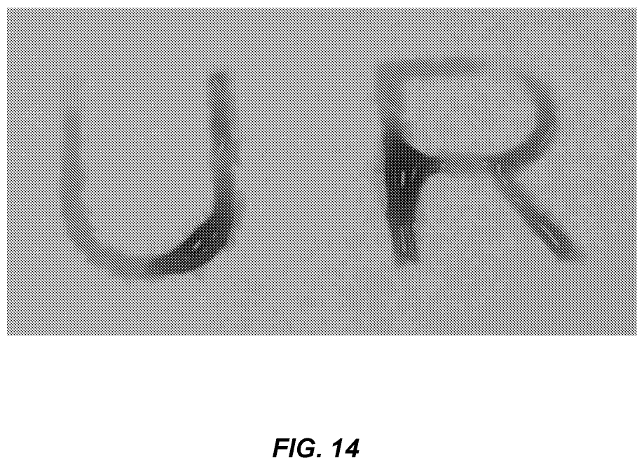

As reported in Example 6, below, an exemplar hydrophobic BorSil polymer dissolved in ethanol was used in place of ink in an office inkjet printer. The printer was set to print a pattern in which the hydrophobic BorSil polymer would coat selected areas of the paper, leaving other areas of the paper uncoated. Paper was then run through the printer and printed with the pattern. An aqueous solution containing a blue food dye was then dripped onto the paper, and soaked into the uncoated areas, but not the coated areas, revealing the letters “UR,” an initialism for the University of Rochester. FIG. 14 is a photograph of the resulting pattern on the paper. Thus, hydrophobic BorSil polymers can be exploited by using them to pattern hydrophobic areas on a material that was originally hydrophilic.

### Creation of Hydrophobic/Hydrophilic Patterns by Piezoelectric Microarrayer or Roller

Examples 1-3, below, report the formation of hydrophobic barriers by applying solutions of the exemplar hydrophobic BorSil polymer to a cellulose-containing material by two different methods: by use of a piezoelectric microarrayer and by rolling printing. Both methods demonstrated the ability to provide defined hydrophobic and hydrophilic areas defining channels for reagents for lateral flow assays. Thus, it is expected that these methods can be used to make paper-based microfluidic assay devices, such as μPADs. Rolling printing is currently considered the lowest cost method for reproducing patterns on paper in high volumes. As reported in Examples 1-3, rolling printing resulted in rapid deposition of hydrophobic regions on two different test cellulose-containing materials, nitrocellulose (“NC”) and Whatman® Grade 1 filter paper.

Stamps and rolling printers have been used to apply ink to fabrics and to paper for several centuries, and it is assumed that practitioners are well familiar with these techniques, which can be readily used to apply the BorSil polymers. In one embodiment, a stamp is made with a raised surface, which is then coated with the polymer to be applied to the cellulose-containing material, such as paper. The stamp is then pressed onto the cellulose-containing material to transfer the polymer onto the material in a positive image, which can either coat the entire surface or which can be in a pattern that defines an area left uncoated (and therefore still hydrophilic) bounded by the hydrophobic polymer coating around it.

A prototype rolling printer was made, bearing a stamp to apply the exemplar hydrophobic BorSil polymer and a stamp to apply the reagents. Studies using the prototype printer to deposit polymer and reagents onto a nitrocellulose substrate and onto paper substrates showed it allowed simultaneous deposition of both the hydrophobic BorSil polymer and the reagents onto the substrate, resulting in two multiplex lateral flow assays. Thus, it is expected that stamp printing or a rolling printer apparatus will be useful for depositing hydrophobic BorSil polymers onto substrates to form microfluidic analytical devices, such as μPADs, as well as in forming patterns of hydrophobic and hydrophilic areas on the surfaces of cellulose-containing materials.

### Creation of Microfluidic Analytical Devices

As noted, the hydrophobic BorSil polymers can be deposited onto cellulose-containing materials to form microfluidic analytical devices, such as μPADs. Such devices typically comprise a material having a surface covered in part by a hydrophobic coating. Most currently available paper-based assays seem to be lateral flow strips rather than multiplex systems that use hydrophobic barriers to form channels. This may be due to problems of scalability using current technology.

In one group of embodiments, the present invention provides new, more temperature stable, and more convenient, ways to provide such patterning, and that allow for devices that can be designed to provide either singleplex or multiplex assays. As used herein, the term “singleplex” denotes a lateral flow strip or a microfluidic analytical device, such as a μPAD, that has a position at which a solution can be placed onto the strip or device, with a single path emanating from the position. The path typically directs the solution to a point on the strip or device holding a reagent that will detect if a single target analyte is present in the solution. In contrast, the term “multiplex” denotes a strip or device that enables detection of more than one analyte, either because it has two or more paths emanating from the position at which the solution is placed onto the strip or device, each of which leads a portion of the solution to a reagent which will react if a target analyte is present in the solution, or because it has a single path, but reagents allowing detection of two or more analytes in the solution as the solution moves along the path. Typically, the reaction of the reagent with the target analytes causes a color change that denotes the presence of the target analyte. In some embodiments, the singleplex or multiplex assays provided by the invention are lateral flow assay devices. Lateral flow assay devices are well-known in the art, as exemplified by, e.g., Koczula and Estrela, Essays Biochem. 2016 Jun. 30; 60(1): 111-120. doi: 10.1042/EBC20150012 and the references cited therein.

For example, the inventive hydrophobic coatings and methods, can be used to define a central, uncoated area on the strip or device, which central area is generally circular, and which further define uncoated first and second arms or paths extending laterally from and fluidly connected to, the central area. The first arm terminates in a first end area that is generally circular, and the second arm terminates in a second end area that is generally circular. The central, circular area typically has a diameter that is larger than that of either of the first and second arms to facilitate the introduction of fluid samples into the area, and typically also larger than that of the diameter of the first end circular area or that of the second end circular area. The uncoated area defined by the surrounding hydrophobic coating allows an aqueous solution to be introduced into the central circular area and allows the solution to flow or to diffuse from the central area towards the first end circular area and the second end circular area, respectively. The first end circular area and the second end circular area typically have dried reagents disposed in them that are reconstituted when the aqueous solution flows or diffuses to them. The reagents are typically selected to reveal if a particular analyte of interest (a “target analyte”) is present in the liquid solution reaching the first end central circular area or second end circular area, respectively, and often contains a reagent that changes color if the analyte of interest is present in the introduced solution.

In some embodiments, the present invention provides microfluidic analytical devices, such as u PADs, in which the device is coated with a hydrophobic BorSil polymer defining an uncoated area having a central circular area, with two or more arms extending laterally therefrom, and terminating in an equal number of ends, each end defined by a generally circular area containing reagents for detecting a target analyte. For example, a single card of paper can be patterned with a hydrophobic coating defining an uncoated area containing a central circular area with five arms radiating out in a starfish-like pattern, or six arms, radiating from a central circular area at angles that render them equidistant from each other.

In some embodiments, the invention provides lateral flow assay devices. Lateral flow assay devices are well-known in the art, as exemplified by, e.g., Koczula and Estrela, Essays Biochem. 2016 Jun. 30; 60(1): 111-120. doi: 10.1042/EBC20150012 and the references cited therein.

Creating Garments, Banners, or Other Materials Coated with Hydrophobic BorSil Polymers

As discussed above, boronic acid-containing siloxane polymer (“BorSil polymers”) can be applied to materials, such as cotton cloth, that have a cellulose-based surface to bind to them, thereby rendering hydrophobic the surface of the materials. In some embodiments, the materials can be garments, such as rain jackets, rain pants, hiking shorts or pants, tee shirts, Polo shirts, golf shirts, or other items in which the ability to shed, rather than to absorb, water may be desirable. In some embodiments, the materials can be used to provide the upper portion on an athletic shoe or as a lining in shoes or boots to reduce water infiltration into the shoe or boot. The BorSil polymers can be used, for example, to make swimwear that does not absorb water and therefore does not require drying after use. In some embodiments, the materials can be used to provide awnings, canopies for tents, or gazebo canopy shelters typically used to provide shade and cover for campers or beachgoers. In some embodiments, the materials may be used for the canopy of an umbrella, including canopies for beach umbrellas. In some embodiments, the BorSil polymers can be used to provide flags, such as American flags, that do not absorb water, allowing the flags to fly in rain that would soak and weigh down materials that do absorb water. Similarly, the BorSil polymers can be bonded to cellulose-containing material to provide create banners, signage, or other items intended for outdoor use to keep them from being weighed down if rained on. By reducing water infiltration into the materials, the BorSil polymers also reduce the chance the materials will become musty or develop mold.

In studies bonding an exemplar BorSil polymer to paper or to cotton, the solution containing the polymer soaked through the material, conferring hydrophobicity to the entire thickness of the material. Thus, clothing that absorbs a solution of a BorSil polymer is expected to remain its water-repellant properties even if its surface is scraped or abraded. This renders materials with hydrophobic BorSil coatings surprisingly more useful than materials on which other hydrophobic coatings have been deposited, but which remain only on the surface of the materials and are therefore susceptible to being removed by abrasion or by being scraped.

Some materials, such as thick cardboard or wood, do not allow the polymer solution to soak through from one side to the other. In these embodiments, the materials can be coated with polymer on each of the sides the practitioner wishes to render hydrophobic. For example, lumber is commonly sold in forms such as 4×4 in which each side is approximately 4 inches in width, and in which each of the two ends is 4 inches×4 inches. The practitioner may wish to render one or more side and one or both ends hydrophobic by bonding to them a BorSil polymer. In some embodiments, the material is wood intended for use as decking. In some embodiments, the material is pressure treated wood. In some embodiments, the material is pressure treated wood for exterior ground contact.

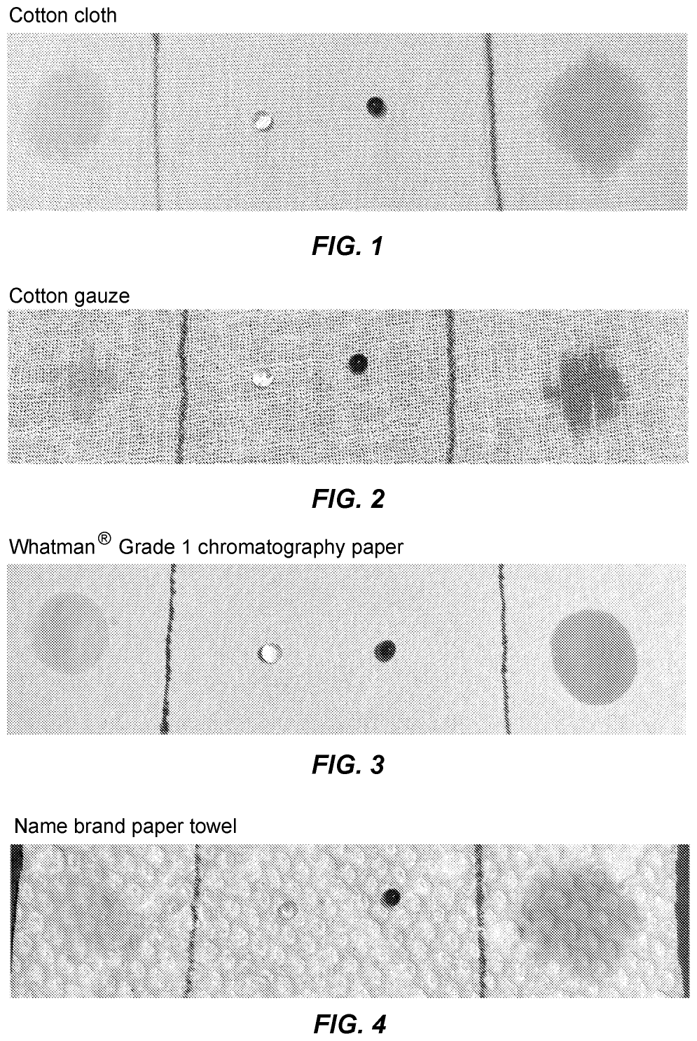

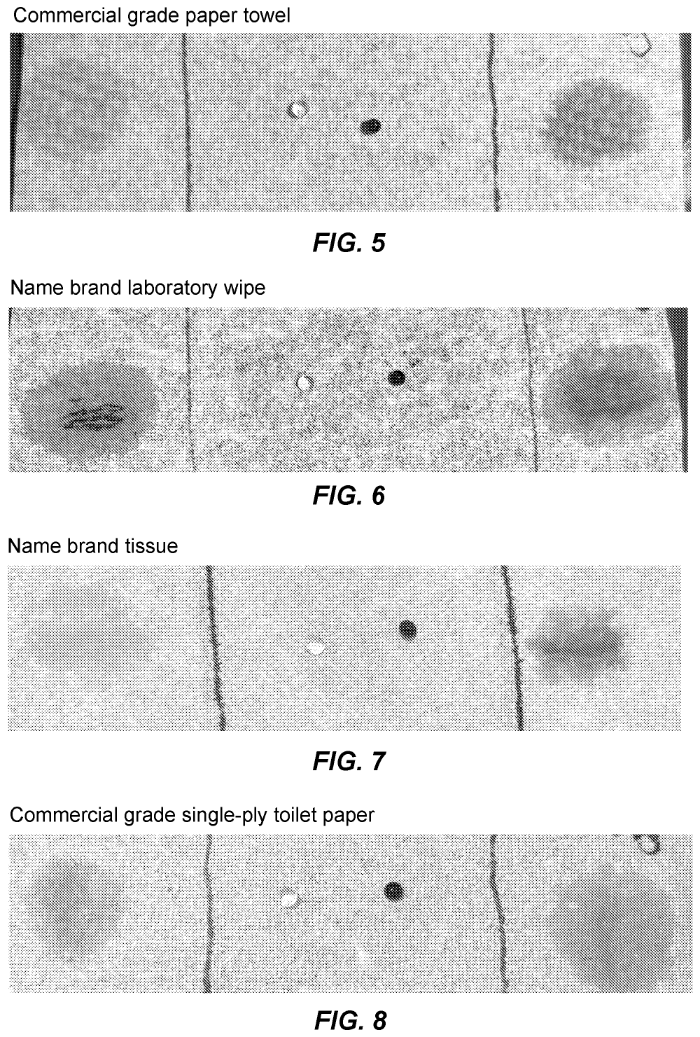

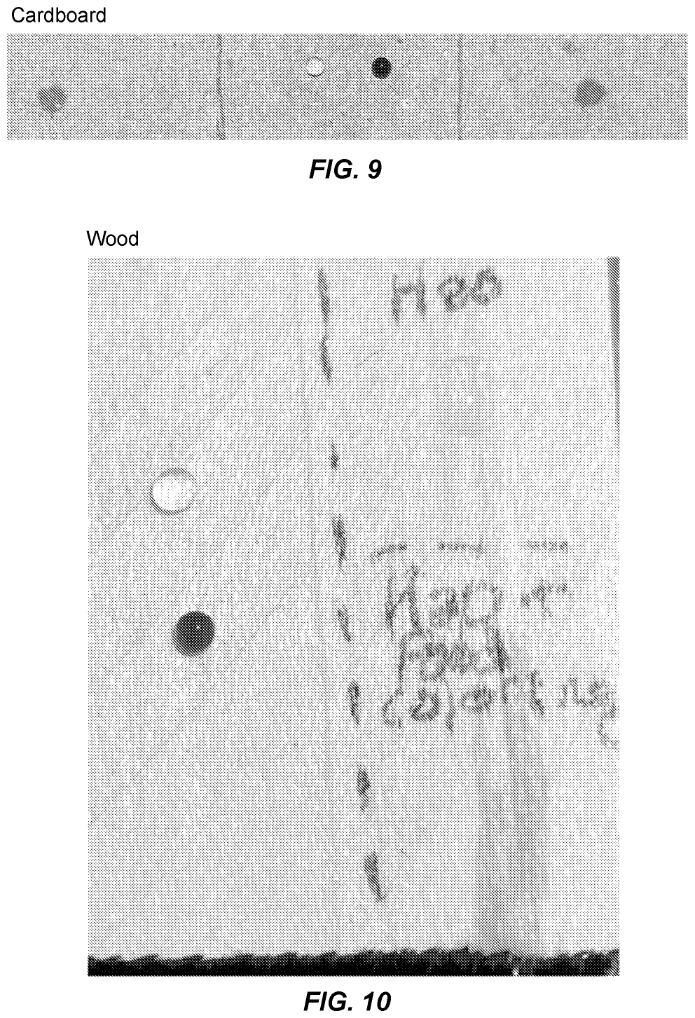

As can be seen from FIGS. 1-10, the exemplar hydrophobic BorSil coating used provides a clear coat, and can be used to provide a hydrophobic coating to garments such as, made of or having a surface of, a cellulose-containing material. Materials can be printed with, for example, a slogan or a corporate logo before the material is coated with the hydrophobic polymer, using an ink or dye that does not prevent the hydrophobic BorSil polymer from bonding to the surface of the cellulose-containing material. Any particular ink or dye of interest can be readily tested to see if it prevents a hydrophobic BorSil polymer from bonding to the surface of the cellulose-containing material by simply using a sample of the ink or dye to print on a sample of the material a test word, logo, or design, allowing the ink or dye to dry, coating with the particular hydrophobic BorSil polymer of interest both the area of the material on which the word or logo has been printed and an area surrounding or adjacent to the printing, under conditions that would allow the polymer to bond to the material, applying water to the material, and determining (i) if the water beads on the material both in the area to which the ink or dye has been applied and to the surrounding or adjacent area of the material to which the ink or dye has not been applied, in which case the ink or dye is suitable for use with the polymer, or (ii) if the water soaks into the material in the area to which the ink or dye has been applied, but beads in the surrounding on area, in which case the ink or dye is not suitable for use. Failure of the water to bead on the material in the area around the portion printed with the ink or dye indicates that the polymer did not bind to the material at all and that the test should be repeated.

In other embodiments, rather than printing the material with a dye or ink before coating the material with a hydrophobic BorSil polymer, the hydrophobic BorSil polymer can be applied to the material in a pattern leaving uncoated an area to later be dyed or printed. Once the polymer has dried on the material, the dye or ink can be applied to the uncoated area, creating a colored area with the shape of the area left uncoated, as shown in FIG. 14. If desired, and if the ink or dye used is one that does not prevent a hydrophobic BorSil polymer from bonding to the surface of the cellulose-containing material, a hydrophobic BorSil polymer can be applied to the previously uncoated area to render that area hydrophobic as well. Any particular dye or ink can be readily tested to see whether it does or does not prevent the hydrophobic BorSil polymer from bonding to the surface of the cellulose-containing material by the test set forth in the preceding paragraph.

### EXAMPLES

### Example 1

This Example sets forth materials and methods used in some of the studies reported herein.

Materials: The potassium iodide, glucose oxidase and horseradish peroxidase used in the glucose detection assay were obtained from EM Science (Darmstadt, Germany), Tokyo Chemical Industry Co. (Tokyo, Japan), and VWR Chemicals (Solon, OH, USA), respectively. The bromothymol blue used in the pH assay was obtained from Educational Modules (Rochester, NY, USA). Coomassie Brilliant Blue G-250 used as an indicator was obtained from Research Organics (Cleveland, OH, USA). Porous substrates included paper towels (Scott Essential C-Fold Paper Towel), Whatman® Q1 filter paper (Cytivia, Marlborough, MA), and FF170HP (Cytivia). Adhesive shipping label (TruBlock, Avery) was used as structural backing to support the paper towel substrate. Stamps were made from Amazing Mold Putty (Alumilite Corp., Kalamazoo, MI) and glued using super glue from Gorilla Glue (Cincinnati, OH). Polyurethane foam (McMaster-Carr Supply Co., Elmhurst, IL) was used in the rolling printer procedure. Materials printed in 3D were designed in SolidWorks® 2018-2019 Student Edition (Dassault Systemes SolidWorks Corp., Waltham, MA) and printed using polylactic acid and a Prusa i3 MK3S (Prusa Research a.s., Prague, Czech Republic).

Glucose Detection Assay: The glucose detection assay used with the piezoelectric microarrayer contained a 5:1 ratio of glucose oxidase/horseradish peroxidase (GOX/HRP) with an enzymatic activity of 15 units/mL in 0.3 M potassium iodide aqueous solution. The assay was performed as described by Bruzewicz et al., Anal Chem., 2008, 80 (9), 3387-3392. The glucose assay used in the polymer stamp assay was prepared in the same manner as for the microarrayer but with an enzymatic activity of 30 units/mL.

pH Assay: The piezoelectric microarrayer pH assay used a 2 mM aqueous solution of bromothymol blue. The rolling printer pH assays used a 1 mM solution of bromophenol blue (BPB) and a 1 mM solution of bromothymol blue, both dissolved in butanol.

Assay Printing via piezoelectric spotting: A piezoelectric microarrayer system (sciFLEXARRAYER SX, Scienion US Inc., Phoenix, AZ) equipped with a standard PDC 90 nozzle was employed to demonstrate a single step print and dry procedure for a multiplexed assay using the exemplar boronic acid polymer. A 3×3 array of nine identical assay designs was configured using the sciFLEXARRAYER SX user interface. Each assay consisted of a 30×36 spot array with a 200 μm pitch, where five 300 pL droplets of reagent were dispensed at each spot. The microarrayer was programmed to dispense a 5% (w/w) solution of BorSilOx polymer dissolved in butanol to create the hydrophobic borders of the assays, followed by deposition of the glucose detection and pH assay solutions in their respective zones (FIG. 3A). A 300 μM aqueous solution of Coomassie blue dye was printed to indicate where the test sample should be applied. All assay reagents were printed on paper towels supported by adhesive shipping labels, and dried at room temperature for 1 hour prior to use.

Three μL of high-resistivity, reagent grade water with modified glucose or 1× PBS with modified pH levels was applied to each assay. Colorimetric changes were observed in the pH region of the assay when buffer (pH 10.5-11.5) was added to the center of the assay, and colorimetric changes were observed in the glucose region of the assay when 0.015%-0.05% aqueous solutions of glucose were added to the assay. After 15 minutes, assays were imaged using an iPhone® SE 2020 camera. Regions of interest were binned for intensity using Fiji (an open source imaging processing software package, built on ImageJ version 2.1.0) and normalized to the intensity of the adjacent regions. Statistical analysis was performed using JMP Pro 15.0.0 (SAS Institute, Cary, NC).

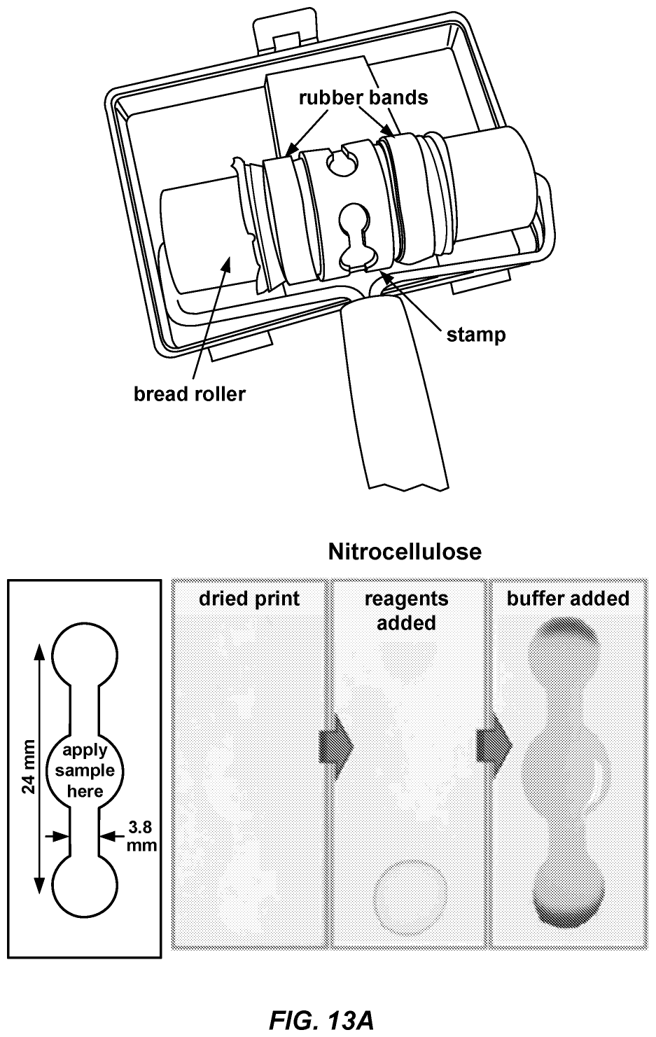

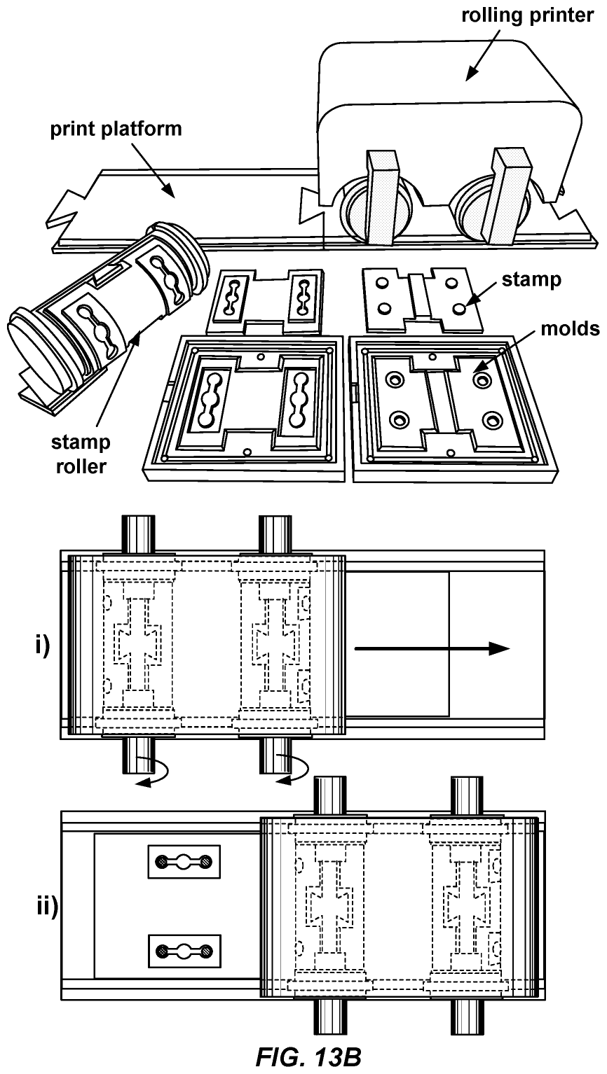

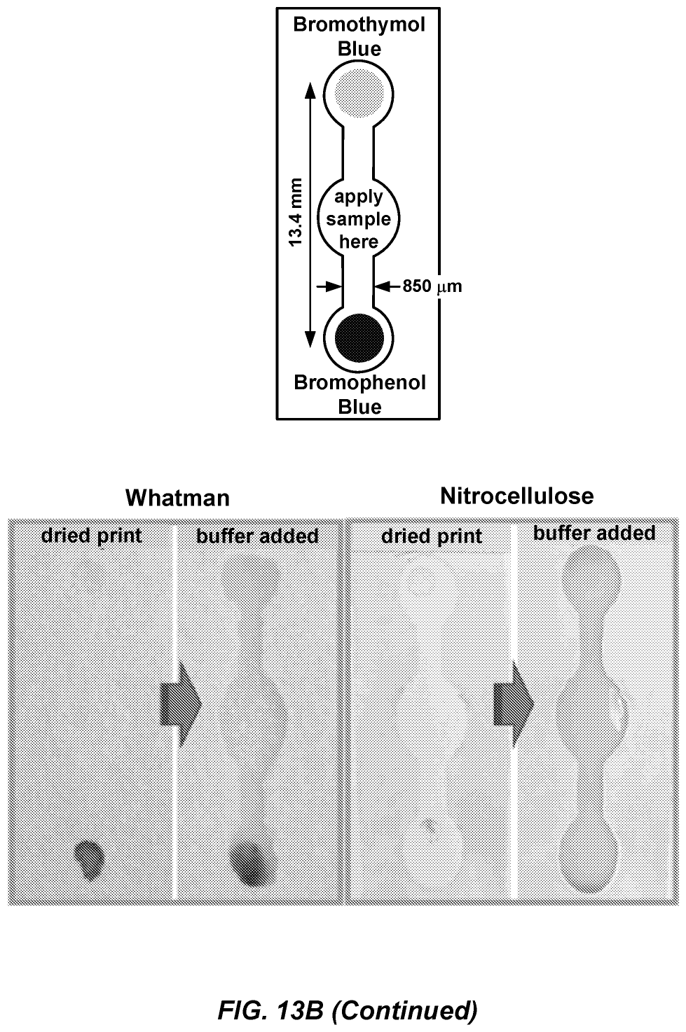

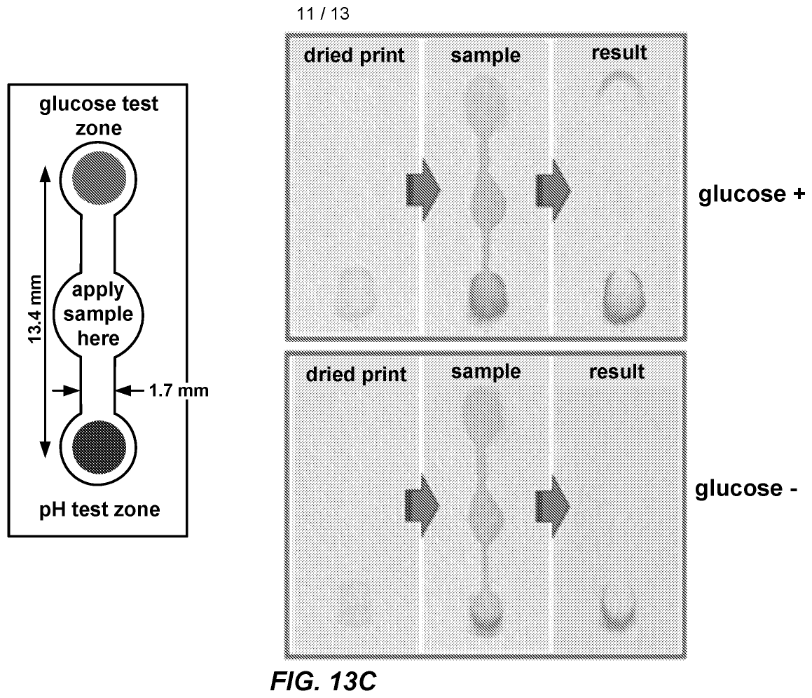

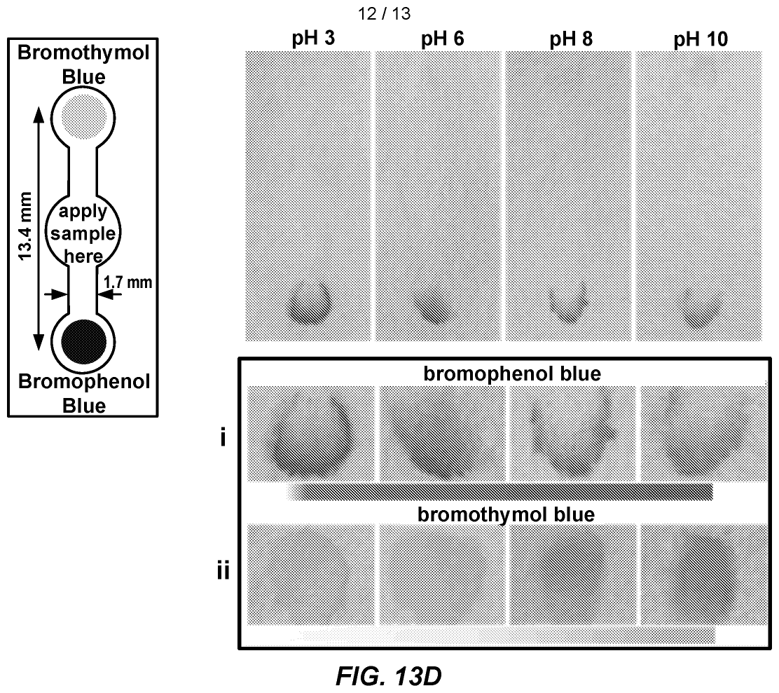

Rolling Printer Assay: Rolling printers were created using 3D printed parts and putty stamps. The 3D printed components of the printer include a body and axels, two rollers, and a print platform designed with grooves to help guide the rolling printer over the substrate. Two versions of designs for rolling printers used in studies underlying the present disclosure are shown in FIGS. 13A and 13B.

The stamps were formed by curing putty in 3D printed molds forming the polymer and reagent stamps which were then glued to the rollers. The reagent stamps were cut after molding to better fit within the boundaries of the hydrophobic barriers. Prior to deposition, the polymer stamp was coated in 5% w/w BorSilOx dissolved in butanol, and pH and glucose sensitive reagents each coated one half of the reagent stamp. While the pH reagent and polymer were dissolved in butanol, the GOX and HRP were dissolved in aqueous solution to maintain their enzymatic activity. Due to the hydrophobic nature of the commercial putty used for the stamps, the aqueous glucose reagents were pipetted as 1 μL droplets onto the stamp reagent pads, while the organic solvent solutes were applied by dabbing the stamps onto polyurethane foam saturated with the pH reagent or polymer solution.

The prepared rolling printer was then placed on the print platform and stamps aligned via notches on the rollers. Once aligned, the printer was rolled over the paper substrate in one smooth pushing motion simultaneously depositing the polymer and reagents onto the paper and resulting in two multiplex lateral flow assays. In some studies, the printed assays were dried for 1 hour at room temperature before liquid samples of either a positive control-high-resistivity, reagent grade water doped with HCl to a pH of 5.8 and 500 mg/dL α-D-glucose—or a negative control—the same water, but doped with HCl to a pH of 2.5—were applied to the center pad. In this experiment, the assays were printed on nitrocellulose and Whatman® Grade 1 filter paper.

In some studies, the glucose reagents described in the preceding paragraph were replaced with bromothymol blue dissolved in butanol and bromophenol blue dissolved in butanol, respectively. A 1× solution of phosphate buffered saline (pH 10) was the applied to the center well of the lateral flow assay.

### Example 2

This Example sets forth the results of some of the studies underlying the present disclosure.

Characterization of substrates treated with BorSilOx: Our use of the BorSilOx polymer for patterning hydrophobic barriers stemmed from an attempt to filter unreacted vinyl phenyl boronic acid from the reaction mixture following the hydrosilylation reaction. Noting that the filter paper became extremely hydrophobic, we sought to systematically study and use this property.

Piezoelectric spotting via microarrayer and assays: Printing using inkjet or piezoelectric spotting is attractive because of the ability to easily modify the pattern being produced. In the case of commercial inkjet printers, the printer hardware is also relatively inexpensive. To test the suitability of piezoelectric printing for the “all in one” production of assays, we printed BorSilOx hydrophobic barriers along with reagents for pH and glucose assays on commercial paper towels backed with adhesive label paper for stability. Barriers printed in this manner were able to contain and direct fluid flow from the base of the assay, up two channels to the assay detection zones.

We initially tested printing the polymer using the microarrayer on nitrocellulose (sometimes referred to herein as “NC”), a substrate commonly used for lateral flow assays. Hydrophobic regions were successfully printed on NC with high boundary resolution due to the uniform structure of the pores. However, the superior accessibility and affordability of paper towels made them a more attractive substrate for assay design studies. Multiplex pH and glucose assays printed using the microarrayer and BorSilOx were used to demonstrate the precision of the microarrayer setup. The pH and glucose detection zones of the assay created were a scant 4.84 and 4.4 mm², respectively. The assays were exposed to solutions of varying glucose concentration or pH to show the semi-quantitative capabilities of assays printed with the BorSilOx polymer on inexpensive, commercially available paper towels.

The glucose samples used in these studies were dissolved in Nanopure™ water, as opposed to the pH samples, which were 1× PBS. We found that α-D-glucose dissolved in 1×PBS had significantly impaired enzymatic reactivity when compared to α-D-glucose dissolved in Nanopure™ water. Without wishing to be bound by theory, we believe this may be due to the α-D-glucose needing to mutarotate to β-D-glucose to be broken down by GOX. It is possible that a component of the 1× PBS was inhibiting mutarotation, and thus, preventing enzymatic activity. Additionally, we were somewhat surprised to observe that the bromothymol blue used for the pH indicator had a significant shift in its pH range, from the expected 6.0-7.6 to approximately 10.5-11.5. Changes to the pKa of bromothymol blue on surface immobilization have been noted before; for example, Ashworth and Narayanaswamy (Mikrochim. Acta 1992, 106, 287-292) reported a change from pKa=7.24 to 9.97 for bromothymol blue immobilized on Amberlite XAD-4 resin. Since this test was to demonstrate the use of BorSilOx in defining a region on a substrate in which to conduct an assay, we were not concerned in this study with the change in detectable pH range of the assay itself.

Rolling Printer: The roll-to-roll process is currently the highest-volume, lowest-cost method for the reproduction of patterns on paper. To evaluate roll-to-roll manufacturability using the exemplar BorSil polymer BorSilOx, we designed a rolling printer device for printing multiplex assays. Using this approach, we were able to demonstrate rapid deposition of hydrophobic regions on NC and Whatman® Grade 1 substrates using the BorSilOx polymer. The NC had empirically superior feature resolution in its assay borders when compared to the less structured boundaries of the Whatman® filter. However, the glucose assay did not work on the NC substrate, and the pH colorimetric reaction was easier to identify on the Whatman® substrate. We believe the uniformity of the NC pore structure contributed to its defined hydrophobic boundaries as opposed to the unstructured cellulose-based Whatman® paper. The failure of the glucose test in the NC may have been due to inhibition of the GOX and HRP enzymes by electrostatic adsorption to the substrate. FF170HP nitrocellulose is also treated with proprietary ingredients to improve its use in lateral flow applications, which may have had a neutralizing effect on the enzymes and a buffering effect on the colorimetric reaction of the pH test. Some examples of rolling printer devices used in some of the studies underlying the present disclosure are shown in FIGS. 13A, top, and 13B.

It was noted that test zone boundaries where reagents and BorSilOx mixed, due to either stamp misalignment or excessive reagent deposition volume, resulte[0001][0001] d in reduced hydrophobicity along that boundary. This can be avoided by increasing the boundary of the test zones to reduce the likelihood of overlapping reagent and BorSilOx solutions during deposition. It is also worth noting that it is difficult to control the volume of reagents deposited using the rolling printer.

To evaluate the contribution of the phenylboronic acid moiety to hydrophobic barrier integrity, in one group of studies, we printed just the exemplar siloxane polymer, (15-18% methylhydrosiloxane)-dimethylsiloxane copolymer, trimethylsiloxane terminated, on Whatman® filter paper, label paper-backed paper towel, and nitrocellulose. While patterns formed cleanly, they were not able to contain water. We also attempted to print BorSilOx pH assays on paper towels, however we had consistent issues with leakage, most likely due to the uneven surface created by the layered fibers of the paper towel matrix.

Studies using a putty stamp cut with a knife showed the stamp could be cut leaving open areas of varied widths, covered with polymer, and the polymer then printed on nitrocellulose, with the polymer defining channels of uncoated nitrocellulose. The channels had widths of 500 μm, 750 μm, and 1 mm, respectively, showing that even relatively unsophisticated methods could create channels of different widths to accommodate, for example, different volumes of samples that might be used to introduce different types of analytes to a μPAD, such as a lateral flow assay.

### Example 3

This Example discusses the results of studies set forth in the preceding Examples.

The studies reported above demonstrate that an exemplar boronic acid-containing siloxane polymer, BorSilOx, can be used for patterning porous media. In some embodiments, piezoelectric printing and a rolling printer method scalable to roll-to-roll printing can be used. The AxiDraw and rolling printer methods in particular show potential for scalable hydrophobic patterning using this polymer.

Piezoelectric spotting of BorSilOx using a microarrayer was used to print the polymer and assay reagents in a single print cycle—a desirable feature for assay manufacturing. Unfortunately, a microarrayer instrument is quite expensive. The microarrayer also had very low throughput (about 9 assays per hour) which is an undesirable feature for scaled manufacturing. However, a redeeming quality of the microarrayer is that it can be used to print high resolution hydrophobic features using BorSilOx.

The AxiDraw's continuous deposition stream and motorized movements allow it to quickly and reproducibly print hydrophobic features defined by computer aided designs. The AxiDraw's low startup cost make it a promising assay manufacturing technique when coupled with BorSilOx.

The rolling printer method is a low-cost solution for hydrophobic patterning using BorSilOx. The polymer also shows promising results for scalable roll-to-roll manufacturing of multiplex assays by eliminating the need for a drying step in between hydrophobic patterning and adding reagents. Depending on the uniformity of the porous media used as a substrate (e.g. nitrocellulose versus Whatman® Grade 1 cellulose), reduced stamp features may be implemented to print smaller assays.

The uses of hydrophobic barriers on porous media created by the BorSilOx polymer extend beyond printing lateral flow assays. The rapid and stable reaction of the boronic acid in BorSilOx with free hydroxyl groups make it advantageous for creating water resistant cotton fabrics or creating intricate patterns on cellulose-based materials.

### Example 4

This Example reports the results of a study of the effect of the application of an exemplar hydrophobic BorSil polymer to a paper substrate.

A sample of Whatman® Grade 1 filter paper was treated with a solution of 15% BorSilOx dissolved in ethanol and then allowed to dry at room temperature. A second, untreated sample of the same paper was used for comparison. When dry, there was no obvious difference in appearance, tactile feel, or mechanical properties of the treated paper compared to the untreated paper. Both samples were placed in a dish and then sprayed with water. The water beaded on the surface of the treated paper, but soaked into the untreated paper. Contact angle measurements confirmed that the polymer treatment resulted in the water contact angle increasing from zero degree (complete wetting) to ˜110-120 degrees, confirming that the paper had been rendered hydrophobic by application of the polymer. The test was repeated using different grades of filter paper, chromatography paper, paper towels, laboratory wipes, and toilet paper.

### Example 5

This Example reports the results of a study of the effect of the application of a solution containing colloidal particles of an exemplar hydrophobic BorSil polymer to a paper substrate.

A sample of paper was soaked overnight in an aqueous 10 mM carbonate buffer at pH 9.9 containing ˜1 wt. % of the exemplar 15% BorSilOx polymer suspended as colloidal particles in the solution.

The paper was dried and then tested for hydrophobicity by contacting it with a stream of water. The paper was found to be hydrophobic, as evidenced by beading of the water on the paper.

### Example 6

This Example reports the results of a study of using a solution containing an exemplar hydrophobic BorSil polymer as an ink in a standard office inkjet printer to apply hydrophobic polymer to paper substrates in a desired pattern.

Solutions of 1-2 wt. % of the exemplar 15% BorSilOx polymer were used as a substitute for ink in an office inkjet printer. Different types of thin paper-tissue paper, laboratory wipes, or paper towels-were fixed to adhesive-backed label paper to provide a support that would allow the thin paper to be fed through the printer from the paper tray and the paper was fed into the printer.

It was found that hydrophobic patterns of the polymer could be printed on the thin paper, and that desired hydrophilic patterns could be created by printing the hydrophobic polymer around them. As an example, hydrophilic areas defining the letters “UR” were created by “printing” the hydrophobic polymer around the letters. The paper was then contacted with blue food coloring in an aqueous solution. As seen in FIG. 14, the dye solution wet and dyed the area of the paper that did not have the hydrophobic polymer on it, dying the paper to reveal the letters “UR.”

### Example 7

This Example reports the results of studies in which a variety of cellulose-containing materials had an area coated with an exemplar hydrophobic BorSil polymer and were then tested for hydrophobicity.

Samples of ten cellulose-containing materials were tested, all by the same procedure. For nine of the materials, lines were drawn on the material dividing the material visually into three sections, left, center, and right. A line was drawn on the tenth material, wood, to divide it visually into two sections, left and right. For the nine materials divided into three sections, ten μL of an exemplar BorSil polymer, 15% BorSilOx, was applied to the center section. For the wood, ten μL of an exemplar BorSil polymer, 15% BorSilOx, was applied to the left section. All ten of the samples were allowed to dry at room temperature for 1 hour.

After the polymer had dried, one 2.5 μL droplet of distilled water and one 2.5 μL droplet of distilled water to which blue food coloring had been added were applied to the section of each of the ten samples to which the polymer had been applied. One 2.5 μL droplet of distilled water was applied to the left section of the materials divided into three parts and on the right-hand section of the wood sample. One 2.5 μL droplet of distilled water to which blue food coloring had been added was applied to the right-hand section of the nine samples divided into three sections, and on the right-hand side of the wood sample, below the spot to which the distilled water droplet was applied.

The results of these studies are shown in FIGS. 1-10. As can be seen, the droplet of distilled water and the droplet with blue food dye formed beads when placed on the area coated with the polymer, but identical droplets placed on areas of the material that had not been coated with the polymer soaked into the material.

### Example 8

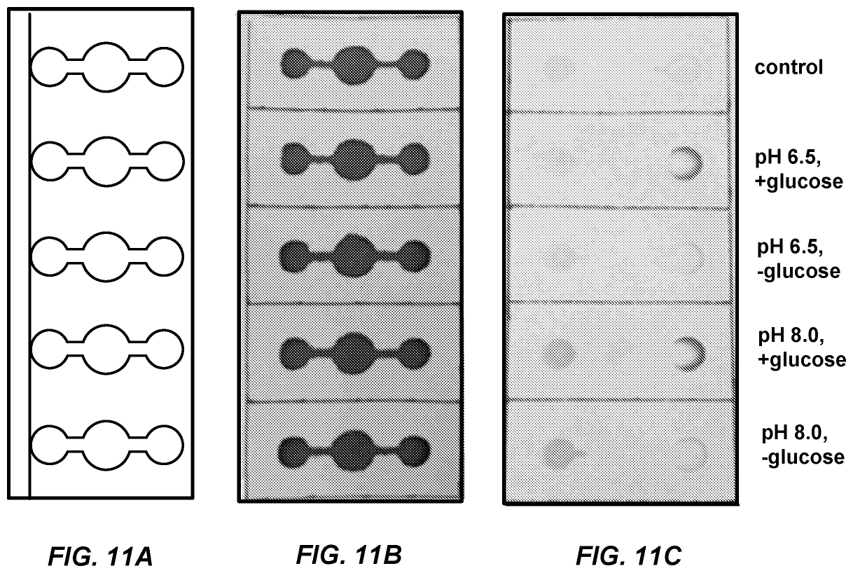

This Example sets forth the results of studies performed to test the utility of an exemplar BorSil polymer, BorSilOx, to form multiple paper-based microfluidic analytical devices (μPADs) on a single piece of paper, thereby providing multiplex capabilities. FIG. 11A is a schematic diagram showing the design of a single paper divided into five such μPADs. Each device in the diagram shown in FIG. 11A is intended to have a hydrophobic coating around and defining a center well for the introduction of a fluid sample, and further around and defining arms fluidly connected to the center well extending from it to two terminal wells, which can be provided with reagents to react with analytes in the fluid sample.

FIG. 11B is a photograph of Whatman® grade 1 filter paper which has had an exemplar BorSilOx polymer deposited on it in a pattern defining five μPADs, as in the schematic diagram set forth in FIG. 11A. Each μPAD consists of a central circular pad (10 mm in diameter) connected to two smaller pads (8 mm in diameter) through linear channels. This pattern was repeated for each u PAD with a continuous line to enable all five patterns to be drawn at constant pen velocity without lifting or stopping the pen. The pattern was drawn using a 5 wt % ethanol solution of BorSilOx deposited at a volumetric flow rate of 1.5 μl s⁻¹ and a pen velocity of 1.6 cm s⁻¹. The filter paper was dried at room temperature, then placed in an oven at 100° C. for 30 minutes. An aqueous methylene blue solution was deposited in the defined, non-coated section pattern and allowed to dry, showing the pattern of the non-coated section.

FIG. 11C is a photograph of a Whatman® grade 1 filter paper which has been made into five u PADs by coating the filter paper with an exemplar BorSilOx polymer defining a central non-coated section as described for FIG. 11B. The left-hand terminal well of each μPAD was provided with a reagent that undergoes a colorimetric change if contacted with an aqueous solution with a basic pH, while the right-hand terminal well was provided with a reagent undergoing a colorimetric change if contacted with an aqueous solution containing glucose. The top μPAD was a control to which no aqueous solution was applied. The second μPAD from the top shows the colorimetric change or changes when a solution with a pH of 6.5, and containing glucose was applied to the central well. The third u PAD from the top shows the colorimetric change or changes when a solution with a pH 6.5, but not containing glucose, was applied to the central well. The fourth μPAD from the top shows the colorimetric change or changes when a solution with a pH of 8, and containing glucose, was applied to the central well. The bottom μPAD shows the colorimetric change or changes when a solution with a pH of 8, but not containing glucose, was applied to the central well.

The results show that coating the surface of an exemplar cellulose-containing material with an exemplar BorSilOx coating formed u PADs that allowed multiplex detection of analytes in a solution.

### Example 9

This Example sets forth materials for, and results of, studies showing the creation and testing of pH and glucose multiplex assays produced on commercial single-ply paper towels using a piezoelectric microarrayer and an exemplar BorSil polymer.

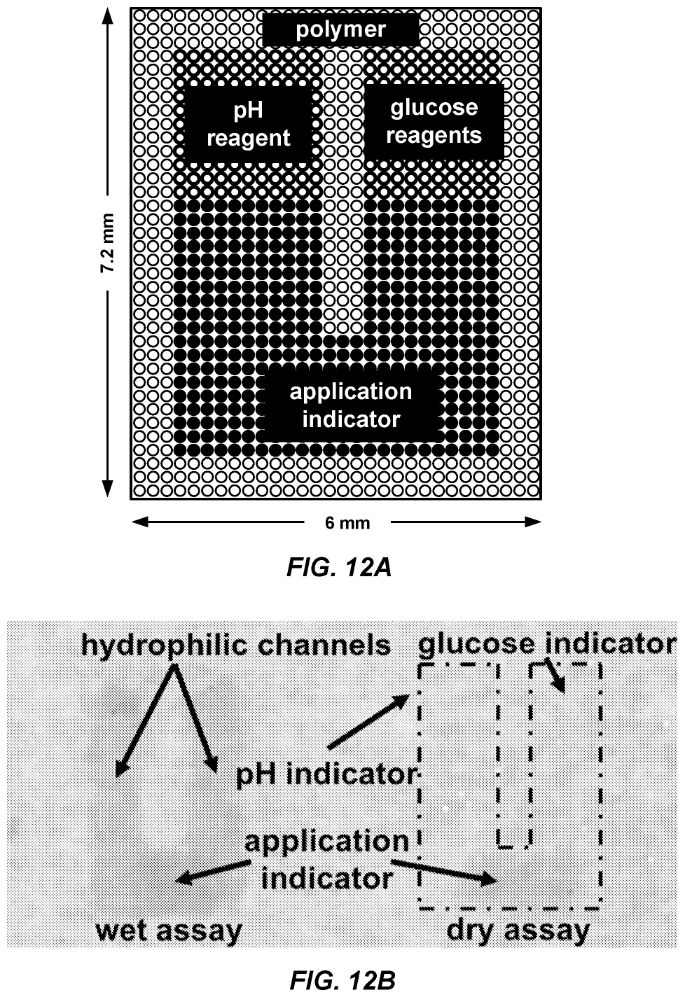

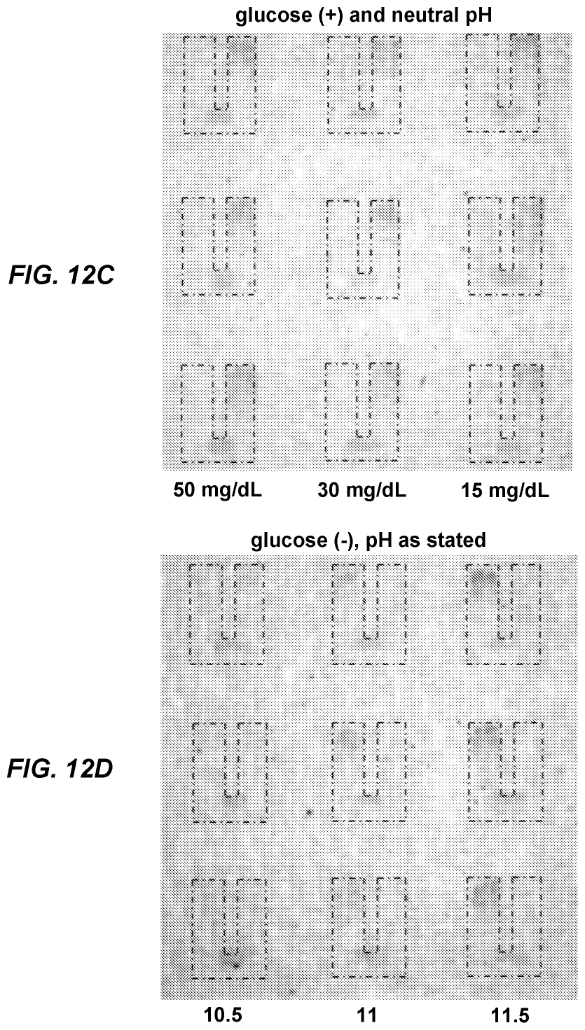

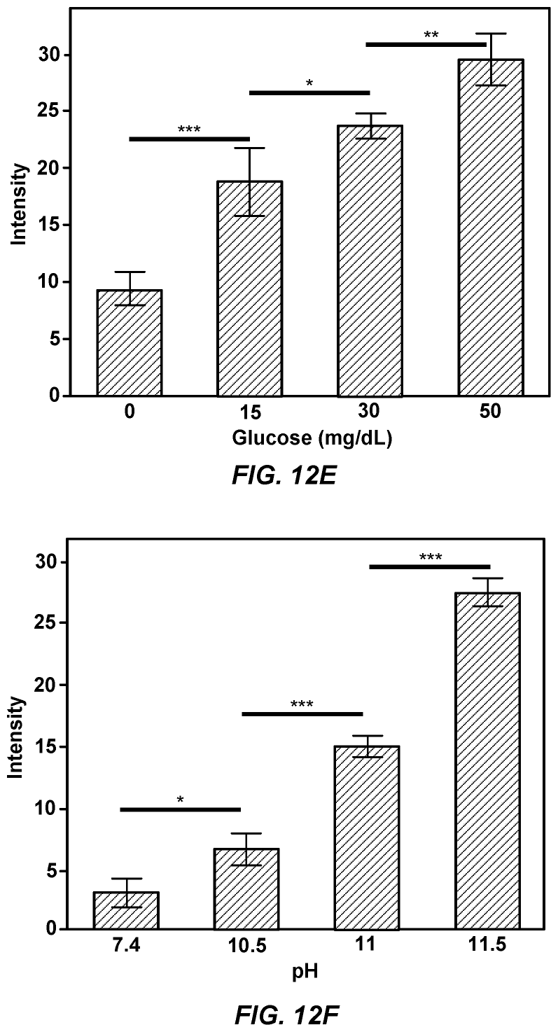

FIG. 12A shows the print layout of an exemplar multiplex assay device printed by the sciFLEXARRAYER SX user interface. An exemplar BorSil hydrophobic polymer, BorSilOx (“polymer”), coats the paper towel in a pattern leaving an uncoated area in the shape of a capital U. The bottom of the uncoated, U-shaped area, may be considered as a first area, and is where the practitioner can apply an aqueous solution to be tested for the presence of an analyte in the aqueous solution. To permit the user to see where to apply the sample, this first area can be colored with an appropriate dye, such as Coomassie blue. The first area at the bottom of the U-shaped area is fluidly connected to the two arms of the U. The left-hand arm in the exemplar assay configuration shown in FIG. 12A is labeled as “pH reagent,” showing that it is to be printed with a reagent that undergoes a colorimetric change when contacted with an aqueous solution having a basic pH (“pH reagent”), while the right-hand arm is labeled “glucose reagents,” showing that it is to be printed with reagents that undergo a colorimetric change when contacted with an aqueous solution containing glucose. For convenience of reference, each of the individual uncoated areas defined by the hydrophobic polymer coating surrounding it is considered a separate assay device, sometimes referred to herein and in the Figures as an “assay.”

FIG. 12B is a photograph showing a paper towel on which two assay devices have been printed. The right-hand assay device (labeled “dry assay”) is formed by an exemplar BorSilOx hydrophobic polymer that has been printed on the towel by a microarrayer, forming a U-shaped uncoated area defining the assay area. Reagents for detecting pH (“pH indicator”) and for detecting glucose (“glucose indicator”), were printed on the towel in the desby the microarrayer. As the printed polymer coating surrounding the uncoated area is hard to see before a liquid sample is applied to the uncoated test area, the boundary of the uncoated area has been denoted by a dotted border line for the reader's convenience. The left-hand assay device (labeled “wet assay”) shows an assay printed on the same towel in the same way, leaving an area not coated by the hydrophobic polymer (the area of the left-hand assay device not coated with the hydrophobic polymer is labeled “hydrophilic channels”). The device on the left has had a liquid sample applied to the

For the assay shown in FIG. 12B, the pH indicator was bromothymol blue and the glucose reagent was a solution of glucose oxidase and horseradish peroxidase. The bottom area of the “U” was dyed with Coomassie blue (in the area labeled “application indicator”) to make it easier for the user to see where to apply a sample to be tested for the presence of analytes of interest. Three μL of water were applied to the “application indicator” area and the paper towel was then allowed to dry. The photo shows that the solution stayed within the area of the paper towel that had not been coated with the exemplar BorSilOx polymer. FIG. 12C. FIG. 12C is a photograph of a paper towel to which an exemplar BorSilOx hydrophobic polymer has been printed to create three columns, with each column containing within it three uncoated areas defining assay devices. The sciFLEXARRAYER SX printed both the polymer coating the towel and the reagents for detection of glucose and of basic pH, as described above for FIG. 12B. For each column, a solution of 1× phosphate buffered saline (“PBS”) was applied that had a neutral pH, but that contained the concentration of glucose shown at the bottom of the column. Due to the size constraints of the sciFLEXARRAYER SX, an assay device was printed on a separate paper towel to provide a control that would allow quantitation of the results. The control assay device was printed in the same manner and using the same reagents as those described above, and was contacted with 1×PBS of neutral pH, but which contained no glucose.

FIG. 12D is a photograph of a paper towel to which an exemplar BorSilOx hydrophobic polymer has been printed to create three columns, each containing three assays printed with the reagents as described for FIG. 12B. For each column, a solution of 1×PBS was applied which contained no glucose, but which was of one of three different pHs, which are listed at the bottom of the respective columns. As with FIG. 12C, a control was run on an assay device printed on a separate sheet of paper towel. In this case, the control was 1× PBS with a pH of 7.4.

FIG. 12E is a graph showing the quantitative results of the assays shown in FIG. 12C versus the control assay, derived using the ImageJ image processing program (National Institutes of Health, Bethesda, MD, available at: https://imagej.nih.gov/ij/) and JMP statistical software (JMP, Cary, NC). Data presented as mean+/−SD, n=3, P-values are calculated using Student's two-tailed t-test, *P≤0.05, **P≤0.01, ***P≤0.001. FIG. 12F. FIG. 12F is a graph showing the quantitative results of the assays shown in FIG. 12D versus the control assay, derived using the ImageJ image processing program and JMP statistical software. Data is presented using same statistical measures as stated for FIG. 12E.

FIG. 13A, top panel, shows a schematic drawing of a prototype roller stamp for applying a BorSilOx hydrophobic polymer to a cellulose-containing surface to coat the surface in a manner defining an uncoated area for conducting a lateral flow assay. In this prototype, a polymer-assay stamp is wrapped around a bread rolling pin and secured with rubber bands. FIG. 13A, bottom panel, shows, on the left, a schematic drawing of the stamp produced by applying BorSilOx polymer to a surface using the polymer stamp. FIG. 13A, bottom panel, then shows the preparation of an assay for detecting pH, by showing, sequentially from the left, BorSilOx polymer applied by the stamp to a nitrocellulose sheet after the polymer has dried, the application of reagents (in this example, bromothymol blue and bromophenol blue applied to the top and bottom wells, respectively) of the assay and, finally, the addition to the assay device of buffer containing the test sample.

FIG. 13B, top panel, is a drawing of an assembled all-in-one rolling printer on a print platform with 3D printed putty molds and resulting assay stamps removed from the molds. The stamp roller is a 3D printed roller with the polymer deposition stamp glued to its surface. FIG. 13B (i) is a cartoon image of an aerial view of the rolling printer being rolled over a section of paper substrate on the print platform. FIG. 13B (ii) is a cartoon image illustrating the completion of the rolling process, resulting in two multiplex lateral flow assays. Under FIG. 13B (ii) is a schematic of the printed assay device and, under that, photographs showing the assay workflow of drying the simultaneously printed BorSilOx and reagents (bromothymol blue and bromophenol blue) on Whatman® filter paper (left two photos) and on nitrocellulose (right two photos), and the addition of test sample to each.

FIG. 13C shows, on the left, a schematic of a printed assay device for multiplex detection of glucose in a test sample and the pH of the test sample. On the right, it presents photographs showing the assay workflow of drying the simultaneously printed BorSilOx and reagents (bromothymol blue and bromophenol blue) on Whatman® Q1. Polymer and reagents were printed on the paper and dried for 1 hour at room temperature before samples were applied to the center zone of the assay device The top right panel shows the assay workflow and result in which a test sample of Nanopure™ water containing HCL providing a pH of 5.8 and 500 mg/dL of α-D-glucose (“glucose+”) was applied to the center well of the device, while the bottom right panel shows the assay workflow and result in which a test sample of Nanopure™ water containing HCL providing a pH of 2.5, but not glucose (“glucose−”) was applied to the center well of the device. The dried assays produced colorimetric results. (The term “Nanopure™ water” is used herein to denote water that was purified using a Barnstead™ Nanopure™ device. As the Nanopure lines appears to have since been replaced by the Barnstead™ GenPure™ line, it is anticipated that products in that line can be used as a source of water purified to laboratory grade.)

FIG. 13C shows, on the left, a schematic of a printed assay device for multiplex detection of the pH of test samples and, on the right, printed pH assay devices defined by a hydrophobic polymer printed at the same time as solutions of the pH detection reagents. The photos were taken following application of 1×PBS with pH values of 3, 6, 8, or 10, respectively. FIG. 13C (i) shows enlarged images of dried bromophenol blue test zones, while FIG. 13C (ii) shows enlarged bromothymol blue test zones. The enlarged images were taken within 1 minute after applying the buffer, as it was noted that the color intensity decreased when the assays were dried.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. An article of manufacture, comprising a boronic acid-containing siloxane polymer bonded to a surface of a cellulose-containing material.

2. The article of manufacture of claim 1, wherein said boronic acid-containing siloxane polymer is the product of a siloxane reacted with a vinyl-R-boronic acid, where “R” is alkyl or aryl.

3. The article of manufacture of claim 2, wherein said vinyl-R-boronic acid is vinyl phenylboronic acid, 4-vinyl phenylboronic acid, 3-vinyl phenylboronic acid, or B-3-buten-1-yl boronic acid.

4. The article of manufacture of claim 2, wherein said vinyl-R-boronic acid is 4-vinyl phenylboronic acid.

5. The article of manufacture of claim 2, wherein said product of a siloxane reacted with a vinyl-R-boronic acid is (methylhydrosiloxane)-dimethylsiloxane copolymer, trimethylsiloxane terminated, (epoxycyclohexylethyl)methylsiloxane-dimethylsiloxane copolymer, (mercaptopropyl)methylsiloxane-dimethylsiloxane copolymer, (chloropropyl)methylsiloxane-dimethylsiloxane copolymer, or polymethylhydrosiloxane homopolymer.

6. The article of manufacture of claim 2, wherein said product of a siloxane reacted with a vinyl-R-boronic acid is (methylhydrosiloxane)-dimethylsiloxane copolymer.

7. The article of manufacture of claim 1, wherein said boronic acid-containing siloxane polymer is the product of reacting aminophenyl boronic acid with epoxide functional silicone, of reacting vinylphenyl boronic acid with thiol functional silicone, or of reacting bis(pinacolato)diboron with chloro-alkyl functionalized silicone.

8. The article of manufacture of claim 1, wherein said boronic acid-containing siloxane polymer is compound 3 (“BorSilOx”) as shown in Scheme 1.

9-12. (canceled)

13. The article of manufacture of claim 1, wherein said cellulose-containing material is cardboard.

14. (canceled)

15. The article of manufacture of claim 1, wherein said cellulose-containing material is a garment.

16-21. (canceled)

22. A method of making an article of manufacture with a hydrophobic surface, said method comprising
(a) contacting a first surface of a cellulose-containing material with a solution of a boronic acid-containing siloxane polymer in a solvent, under conditions allowing said boronic acid-containing siloxane polymer to bond to said first surface, and
(b) drying said solution on said first surface,
thereby making an article of manufacture with a first hydrophobic surface on said cellulose-containing material.

23. The method of claim 22, wherein said drying in step (b) is at a temperature above room temperature.

24-30. (canceled)

31. The method of claim 22, wherein said cellulose-containing material is cardboard.

32. (canceled)

33. The method of claim 22, wherein said cellulose-containing material is a garment.

34. The method of claim 22, further wherein said cellulose-containing material has a second surface and wherein said second surface is contacted with a solution of a boronic acid-containing siloxane polymer in a solvent, under conditions allowing said boronic acid-containing siloxane polymer to bond to said second surface.

35-36. (canceled)

37. The method of claim 22, wherein said boronic acid-containing siloxane polymer is the product of reacting a siloxane with a vinyl-R-boronic acid, where “R” is alkyl or aryl.

38. The method of claim 37, wherein said vinyl-R-boronic acid is vinyl phenylboronic acid, 4-vinyl phenylboronic acid, 3-vinyl phenylboronic acid, or B-3-buten-1-yl boronic acid.

39. (canceled)

40. The method of claim 37, wherein said product of reacting a siloxane with a vinyl-R-boronic acid is (methylhydrosiloxane)-dimethylsiloxane copolymer, trimethylsiloxane terminated, (epoxycyclohexylethyl)methylsiloxane-dimethylsiloxane copolymer, (mercaptopropyl)methylsiloxane-dimethylsiloxane copolymer, (chloropropyl)methylsiloxane-dimethylsiloxane copolymer, or polymethylhydrosiloxane homopolymer.

41. (canceled)

42. The method of claim 22, wherein said boronic acid-containing siloxane polymer is the product of reacting aminophenyl boronic acid with epoxide functional silicone, of reacting vinylphenyl boronic acid with thiol functional silicone, or of reacting bis(pinacolato)diboron with chloro-alkyl functionalized silicone.

43-53. (canceled)

54. The method of claim 22, wherein said solution is applied to said cellulose-containing material by rolling printing.
